(19) United States
(12) Patent Application Publication
(10) Pub. No.: US 2003/0028622 A1
(43) Pub. Date: Feb. 6, 2003

(54) License management server, terminal device, license management system and usage restriction control method

(76) Inventors: Mitsuhiro Inoue, Osaka-shi (JP); Ryuichi Okamoto, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/211,549

(22) Filed: Aug. 5, 2002

(30) Foreign Application Priority Data
Aug. 6, 2001 (JP) 2001-238248

(51) Int. Cl. G06F 15/16

(52) U.S. Cl. 709/219

(57) ABSTRACT

A management server (5) manages usage rules in accordance with which terminals use contents, and includes a usage rule database (52), a parental control unit (56), a parental database (53), and a ticket producing unit (54). The usage rule database (53) stores usage rule information (13˜14) that associates each user with the usage rules. The parental control unit (56) obtains, from a parent terminal (6), parental information (15˜16) that is a request made by the parent terminal (6) for placing a restriction on content usage by a child terminal (7), and the parental database (53) stores the obtained parental information (15˜16). On receiving, from the parent terminal (6), a content request made by a user of the child terminal (7) for content use, the ticket producing unit (54) adds a restriction shown in the stored parental information for the child terminal (7) to a usage rule shown in the stored rule information for the child terminal (7) to produce a new usage rule, produces a license ticket that permits content use under the new usage rule, and sends the license ticket to the parent terminal (6).

### TECHNICAL FIELD

The present invention relates to a usage restriction control system in which a terminal device used by a child plays a distributed content in accordance with usage restrictions placed by a parent of the child.

### BACKGROUND ART

A variety of contents, including television and radio programs, video images, music from CD (compact disc), and cartoons, are now distributed via the Internet, and it has become possible for users of any ages enjoy such digital contents (hereafter simply called “contents”) in homes with a computer such as a personal computer (PC). As a result, children are now more likely to be exposed to violence and pornographic images in some of these contents. Accordingly, homes receiving contents are now required to keep children away from images and ideas of contents that can deter children's sound mental development. As a result of such increasing concern, a parental system is now attracting much attention.

To protect children from such deleterious contents, a conventional content distributing system asks a user his age before he purchases a content. When the user is underage, the distributing system does not sell contents for adults to this user. When the user places an order by using a credit card, the content distributing system regards the user as an adult and allows distribution of contents for adults. In the case of DVD (digital versatile disc) video, a parental code represented by numerals from “1” to “8” is set beforehand in each sold DVD disc. A parent sets in a home sets, in a playback device in the home, a parental code representing the level of contents the parent allows children to view. As a result, the playback device in the home cannot play a DVD with the parental code higher than the code that is set in the playback device. For instance, the playback device with the parental code “2” cannot play a DVD with the parental code “3”. Changing the parental code of the playback device requires a four-digit password, and therefore children cannot change the parental code of the playback device at will.

Most of the above techniques, however, either completely restrict usage of the entire content or do not restrict it at all, and cannot place more precise restrictions, such as restrictions on duration of the content use or on a number of usages. Although DVD video has a function that allows a parent user to remove scenes of violence, for instance, from the DVD video before it is played, such removable scenes in the DVD video are predetermined, and therefore the parent user cannot remove scenes other than such predetermined scenes. Neither can the parent user create his or her own level of the parental code. In this way, the conventional techniques do not allow parents to set their own rules and restrictions for content use, although these techniques allow predetermined rules and restrictions to be set.

In view of these problems, the present invention aims to provide a parental system (a license management system) that allows a parent in each home to set content-usage restrictions more specific to each child in a variety of restriction methods.

### DISCLOSURE OF THE INVENTION

The license management server of the present invention manages usage rules in accordance with which terminals use contents. The terminal devices include a first terminal device used by a first user and a second terminal device used by a second user. This license management server includes: an information storing unit operable to store license information that associates a usage rule with either (a) each of the first terminal device and the second terminal device or (b) each of the first user and the second user; a restriction managing unit operable to obtain restriction information from either the first terminal device or the first user and to store the restriction information, which shows a restriction on content use by either the second terminal device or the second user; and a ticket issuing unit operable to (1) obtain a usage request from either the first terminal device or the first user, the obtained usage request requesting content use by either the second terminal device or the second user, (2) add, in response to the obtained usage request, the restriction shown in the restriction information in the restriction managing unit to a usage rule associated by the license information with one of the second terminal device, and the second user to produce a new usage rule, (3) produce a first license ticket that permits content use under the new usage rule, and (4) send the first license ticket to either the first terminal device or the first user.

That is to say, the above license management server receives a request that contains the restriction information from either the first terminal device or the first user, who is a parent of a family in a home, of the first terminal. This request makes a request for restricting content use by either the second terminal or the second user, who is a child of the parent in the home, of the second terminal. In response to this request, the license management server generates the license ticket that contains a usage rule to which the restriction shown in the restriction information is added. With this construction, the first user (parent) can set a variety of content usage restrictions in accordance with growth of each second user (child), although many of conventional license management servers are capable of only setting predetermined or uniform restrictions on content use by children. The license management server of the present invention also allows the first user to create different restriction information for each child.

A terminal device of the present invention makes a request for content use to a license management server that manages usage rules for contents. This terminal device includes: a restriction storing unit operable to obtain and store restriction information showing a restriction to be placed on content use by either a certain terminal device or a certain user of the certain terminal device; a ticket requesting unit operable to make a ticket request to the license management server in response to a request from either the certain terminal device or the certain user, the ticket request requesting a license ticket that permits content use under a certain usage rule; a ticket obtaining unit operable to obtain the requested license ticket from the license management server; and a ticket issuing unit operable to (1) add the restriction shown in the restriction information in the restriction storing unit to the certain usage rule shown in the obtained license ticket to produce a new usage rule, (2) produce a restricted license ticket that permits the content use under the new usage rule, and (3) send the restricted license ticket to either the certain terminal device or the certain user.

This terminal device obtains, from the parent user of the terminal, the restriction information showing the restriction to be placed on content use by the certain terminal device or the certain user, who is a child of the parent user, of the certain terminal device. The terminal device of the parent user then generates the restricted license ticket based on the obtained restriction information. This construction enables the terminal device of the parent user to dynamically produce a restricted license ticket and set a greater variety of restrictions specifically determined in accordance with growth of each child in each home and with various situations.

### BRIEF DESCRIPTION OF DRAWINGS

FIG. 1 is a block diagram showing the construction of a parental system of the first embodiment according to the present invention.

FIG. 2 shows an example data structure of user information stored in the user database shown in FIG. 1.

FIG. 3 shows an example data structure of usage rule information stored in a usage rule database shown in FIG. 1.

FIG. 4 shows an example data structure of parental information stored in a parental database shown in FIG. 1.

FIG. 5 shows an example data structure of a license ticket that is produced by a ticket producing unit shown in FIG. 1 and that is sent to a parent terminal shown in FIG. 1.

FIG. 6 is a sequence diagram showing an example procedure for communication between a management server, the parent terminal, and a child terminal that makes a content distribution request and that uses the content on which parental usage restrictions are placed.

FIG. 7 shows an example of a parental setting screen sent from the management server in response to a parental setting request from the parent terminal.

FIG. 8 is a block diagram showing the construction of a parental system of the second embodiment according to the present invention.

FIG. 9 shows an example data structure of usage rule information stored in a usage rule database shown in FIG. 8.

FIG. 10 shows how a ticket revising unit shown in FIG. 8 revises a license ticket as one example.

FIG. 11 is a sequence diagram showing an example procedure for communication between a management server, a parent terminal, and a child terminal that makes a content distribution request and that uses the content on which parental usage restrictions are placed.

FIG. 12 shows how the ticket revising unit produces a revised license ticket for the child terminal according to the first example modification.

FIG. 13 shows how the ticket revising unit produces a restriction ticket according to the second example modification.

FIG. 14 shows how the ticket revising unit produces a revised license ticket for the child terminal according to the third example modification.

FIG. 15 shows an example of a child terminal registration screen displayed by the parent terminal.

FIG. 16 shows an example child terminal list that is produced based on data entered to the child terminal registration screen shown in FIG. 15 and that is stored in a request history storing unit.

FIG. 17 shows an example of a restriction setting screen presented by a parental setting unit shown in FIG. 8.

FIG. 18 shows an example of a second restriction setting screen invoked by the restriction setting screen shown in FIG. 17.

FIG. 19 shows an example of a content category table stored in the parental setting unit.

FIG. 20A shows an example data structure of parental information produced based on data entered to the second restriction setting screen shown in FIG. 18.

FIG. 20B shows another example data structure of parental information stored in a parental storing unit shown in FIG. 8.

FIG. 20C shows another example data structure of parental information stored in the parental storing unit.

FIG. 20D shows another example data structure of parental information stored in the parental storing unit.

FIG. 20E shows the other example data structure of parental information stored in the parental storing unit.

### BEST MODE FOR CARRYING OUT THE INVENTION

First Embodiment

The following describes the first embodiment of the present invention with reference to drawings.

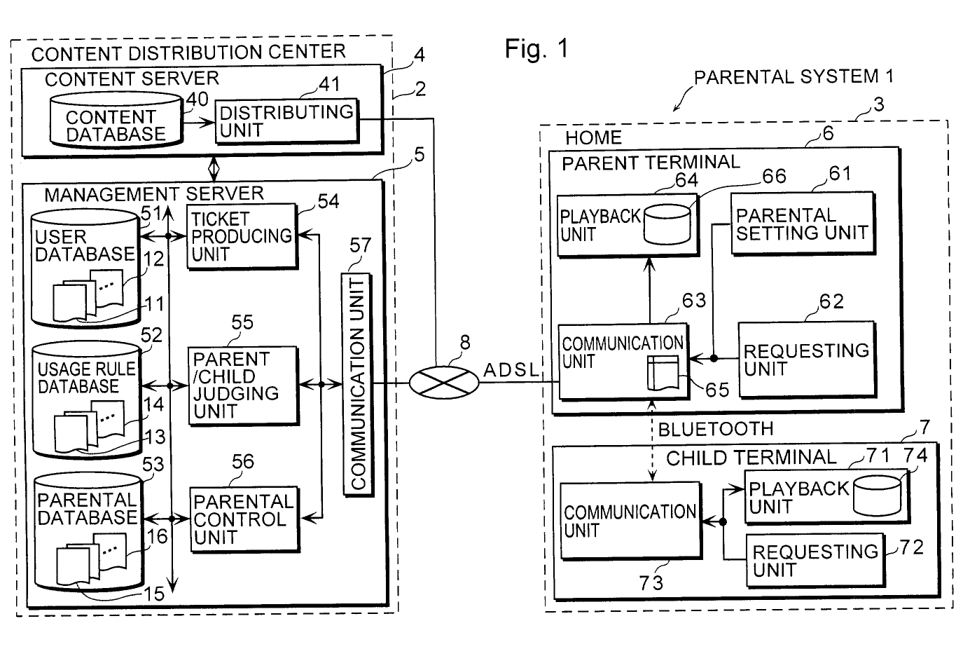

FIG. 1 is a block diagram showing the construction of a parental system 1 of the first embodiment. In this parental system 1, a communication/distribution system at a content distribution center collectively manages usage license of contents such as video, games, and copyrighted productions, and places restrictions on usage of contents distributed to children according to instructions from their parents, thereby preventing children from being exposed to contents that may deter their sound mental development. The parental system 1 comprises the following elements: a content server 4 and a management server 5 installed in the content distribution center 2; a parent terminal 6 and a child terminal 7 used by a parent and a child of a family in each of a plurality of homes 3; and a communication network 8, such as high-speed public broadband ADSL (asymmetric digital subscriber line), that connects the content server 4, the management server 5, and the parent terminal 6 to one another.

The content distribution center 2 distributes a content, which cannot be used on its own, in response to a content request for content distribution from the user. The content distribution center 2 also distributes a license ticket that enables a content purchased by the user to be used by the user, in response to a ticket request that requests issuance of the license ticket. The license ticket includes, as its main components, a content key that decrypts encryption of the content, and usage rules that permit requested content use within a usage right purchased by the user in advance.

The content request is a command sent from a terminal (the parent terminal 6 and the child terminal 7) in the home 3 to request distribution of a content desired by the user. The content request includes, as its main components, a terminal identifier (ID) of the terminal making the content request, and a content ID of the desired content.

The ticket request is a command to request issuance of the license ticket, and includes a terminal ID of a terminal making the ticket request, a content ID of a content the user wishes to use, and usage rules requested by the user for the content.

Note that the content request and the ticket request made by the child terminal 7 include not only the terminal ID of the child terminal 7 but also the terminal ID of the parent terminal 6, although the content and ticket requests made by the parent terminal 6 only include the terminal ID of the parent terminal 6.

When permitted to use the content, the user's terminal (the parent terminal 6 and the child terminal 7) decrypts encryption of the content by using the content key included in the issued license ticket, and plays the decrypted content while always referring to the usage rules in the license ticket.

The content server 4 is a computer system connected to the management server 5 with Local Area Network (LAN) or the like, distributes the requested content to the user's terminal in response to the content request from the user, and includes a content database 40 and a distributing unit 41.

The content database 40 is a storing unit, such as a hard disk, that stores encrypted contents and content keys for decrypting the encrypted contents.

The distributing unit 41 is a processing unit achieved by a program and the like, reads a content designated by the management server 5 from the content database 40, and distributes the read content via the communication network 8 such as the Internet.

The management server 5 is a computer system that manages usage license of contents and their distribution. In response to a ticket request, the management server 5 judges whether the ticket request is made by the child terminal 7. If not, the management server 5 issues, to the terminal making the request, a license ticket that enables playback of the requested content under certain usage rules. When judging that the request is made by the child terminal 7, the management server 5 attaches additional usage rules, which are provided in advance according to a request from the parent terminal 6, to a usage range so as to produce a new license ticket for the child terminal 7, and issues it to the requesting terminal.

The management server 5 is roughly divided into three databases (a user database 51, a usage rule database 52, and a parental database 53) and four processing units (a ticket producing unit 54, a parent/child judging unit 55, a parental control unit 56, and a communication unit 57). The three databases are achieved by hard disks and the like, and the four processing units are achieved by programs and the like.

The user database 51 stores user information 11˜12 for each user of child terminals 7 as well as parent terminals 6. The user information 11˜12 includes personal information on each user and an ID of a terminal used by the user for content playback.

The usage rule database 52 stores, for each user of the parent terminals 6, usage rule information 13˜14 showing a usage rule of each content.

The parental database 53 stores, for each user of the child terminals 7, parental information 15˜16. The parental information 15˜16 shows, for each user and each content, restrictions on use of the content, which are provided by a parent of the child user.

The ticket producing unit 54 operates in accordance with a judging result of the parent/child judging unit 55. When the parent/child judging unit 55 judges that the license ticket is requested by the parent terminal 6, the ticket producing unit 54 reads, from the usage rule information 13˜14, usage rules that correspond to the parent user and to the content specified by the content ID included in the ticket request. The ticket producing unit 54 then subtracts, from values representing the read usage rules, values representing usage rules currently requested in the ticket request, so that the read usage rules are changed and placed back in the usage rule information 13˜14. After this, the ticket producing unit 54 produces usage rules for a license ticket that show the above requested usage rules, and writes the produced usage rules and a content key sent from the content server 4 into the license ticket. The ticket producing unit 54 then attaches, to the license ticket, the terminal ID of the parent terminal 6 as a destination of the ticket, and sends the ticket via the communication unit 57.

On the other hand, when the parent/child judging unit 55 judges that the license ticket is requested by the child terminal 7, the ticket producing unit 54 refers to the terminal ID, which is attached to the ticket request, of the parent terminal 6, and reads usage rules corresponding to the read terminal ID and to a content requested in the ticket request. The ticket producing unit 54 then subtracts, from values representing the read usage rules, values representing usage rules requested in the ticket request, so that the read usage rules are changed and placed back in the usage rule database 52. After this, the ticket producing unit 54 performs operation different from the above operation performed in response to the ticket request from the parent terminal 6. That is to say, the ticket producing unit 54 obtains usage restrictions from the parental control unit 56 and adds the obtained usage restrictions to the usage rules requested in the ticket request to produce usage rules for the child user. The ticket producing unit 54 then attaches a content key to the produced child usage rules, and writes the user ID of the child terminal 7 to produce a license ticket for the child user. After this, the ticket producing unit 54 attaches, to the child license ticket, the terminal ID of the child terminal 7 as a destination of the ticket, sends the license ticket via the communication unit 57 to the parent terminal 6, and has the distributing unit 41 distribute the requested content.

In addition to the above operations, the ticket producing unit 54 performs operation in response to a variety of requests, except for a parental setting request (described later), from the parent terminal 6. For instance, in response to requests from the parent terminal 6, the ticket producing unit 54 changes the user information 11˜12 in the user database 51 by adding and deleting information to and from it, and updates the usage rule information 13˜14 in the usage rule database 52 by adding and deleting information to and from it.

The parent/child judging unit 55 judges from the terminal ID in the received ticket request whether the request is made by the parent terminal 6 or the child terminal 7. This judgment is possible because a ticket request from the parent terminal 6 only includes its own terminal ID, whereas a ticket request from the child terminal 7 includes its own terminal ID and the ID of the parent terminal 6.

When the parent/child judging unit 55 judges that the ticket request is made by the child terminal 7, the parental control unit 56 specifies the user ID of the child terminal 7 by referring to the user information 11˜12 and the terminal ID of the child terminal 7 contained in the request. In accordance with the specified user ID and the content ID of the requested content, the parental control unit 56 reads, from the parental information 15˜16, usage restrictions provided in advance for the user of the child terminal 7, and sends the read usage restrictions to the ticket producing unit 54.

In response to a parental setting request from the parent terminal 6, the parental control unit 56 also produces and changes the parental information 15˜16 provided for the child terminal 7. In response to a parental deletion request that requests to delete certain usage restrictions from the parental information 15˜16, the parental control unit 56 deletes the restrictions, thereby updating the parental database 53.

The communication unit 57 receives requests, such as the content request, the ticket request, and the parental setting request, from the parent terminal 6, and sends a license ticket produced in the management server 5 in response to a ticket request to each requesting home 3.

Terminals used in each home 3 consist of the parent terminal 6 and the child terminal 7 that are connected to each other via wireless communication, such as Bluetooth.

The parent terminal 6 is used by a parent in a family in the home 3 and is a sole terminal connected to the communication network 8 such as high-speed broadband ADSL. The parent terminal 6 is achieved by a PC and the like, requests the management server 5 to set usage restrictions for each child terminal 7 in the same home 3. The parent terminal 6 also relays data to/from the child terminal 7 by transferring the content request and the ticket request from the child terminal 7 to the management server 5 and transferring the requested content and the child license ticket from the management server 5 to the child terminal 7.

The parent terminal 6 can be roughly divided into four processing units: a parental setting unit 61, a requesting unit 62, a communication unit 63, and a playback unit 64, of which the units 63 and 64 include a storing unit (i.e., a history storing unit 65 and a content storing unit 66) achieved by a hard disk and the like.

The parental setting unit 61 presents a parental setting screen to the user of the parent terminal 6, and sends a parental setting request composed of data entered by the user using the parental setting screen to the management server 5 via the communication unit 63.

Through a dialog with the management server 5, the requesting unit 62 receives menu screens responding to various types of requests other than the parental setting request, and presents the received menu screens to the user. The requesting unit 63 also sends, to the management server 5 via the communication unit 63, various types of requests that are made by the parent terminal 6 and that are composed of data entered via the menu screens.

The communication unit 63 sends various types of requests made by the parent terminal 6 and the child terminal 7 in the home 3 to the management server 5, receives a content and a license ticket from the management server 5, and transfers them to either the playback unit 64 or 71.

In more detail, whenever sending a content request, the communication unit 63 records a history of the sent content request in the history storing unit 65. This history includes the following: the ID of a terminal that made the content request; a date on which the request was made; and the ID of the requested content. When sending the ticket request made by the child terminal 7 to the management server 5, the communication unit 63 attaches the ID of the parent terminal 6 to the request.

On receiving the requested content, the communication unit 63 refers to the ID of the received content and the history storing unit 65 to specify the terminal that made the request for the content, and sends the content to a playback unit of the specified terminal. Whenever sending the content to the playback unit, the communication unit 63 deletes the history corresponding to the sent content and its ID.

On receiving a license ticket, the communication unit 63 refers to the destination terminal ID attached to the received license ticket, and sends the license ticket to one of the playback units 64 and 71 of the terminal specified by the attached terminal ID.

The playback unit 64 includes a playback module with a tampering-resistant mechanism, such as an MPEG (Moving Picture Experts Group) decoder, stores the received license ticket in the content storing unit 66, and decodes the received content in units of predetermined data lengths of the content by using the content key in the content storing unit 66. The playback unit 64 then has the playback module perform in-stream playback in accordance with usage rules shown in the license ticket. When not performing in-stream playback, the playback unit 64 stores the received content in the content storing unit 66, and plays the content in response to a playback instruction inputted from the user.

The history storing unit 65 is a region storing the history of content requests sent by the communication unit 63.

The content storing unit 66 stores the content and the license ticket distributed to the parent terminal 6.

The child terminal 7 is used by a child of the family in the home 3, and is a PC connected to the parent terminal 6 via local wireless communication such as Bluetooth to receive the content and the child license ticket from the content distribution center 2 via the parent terminal 6. The child terminal 7 plays the received content in accordance with usage rules shown in the child license ticket. The child terminal 7 is roughly divided into three processing units (a playback unit 71, a requesting unit 72, and a communication unit 73) achieved by programs and the like. The playback unit 71 includes a content storing unit 74 achieved by a hard disk and the like.

The playback unit 71 includes a playback module with a tampering-resistant mechanism, such as an MPEG decoder, and performs in-stream playback for the content distributed via the parent terminal 6 in response to a playback instruction inputted by the user via a display screen. The playback unit 71 may also store the received content into the content storing unit 74 until it receives such a playback instruction, and play the content in response to the playback instruction. The playback is performed in accordance with usage rules shown in the child license ticket.

The requesting unit 72 accesses the management server 5 via the parent terminal 6 to receive a menu screen responding to each request, and presents the received menu screen to the user to receive an input. The requesting unit 72 then sends a content request and a ticket request including such input of the user to the communication unit 73. When sending the content request and the ticket request, the requesting unit 72 attaches the terminal ID of the child terminal 7 as the requesting terminal to these requests.

The communication unit 73 includes a Bluetooth communication module, and transfers data to/from the communication unit 63 of the parent terminal 6. In more detail, the communication unit 73 sends the content request and the ticket request, and receives the content and the license ticket.

The content storing unit 74 stores the content and the license ticket distributed to the child terminal 7.

The communication network 8 is achieved by the Internet and the like.

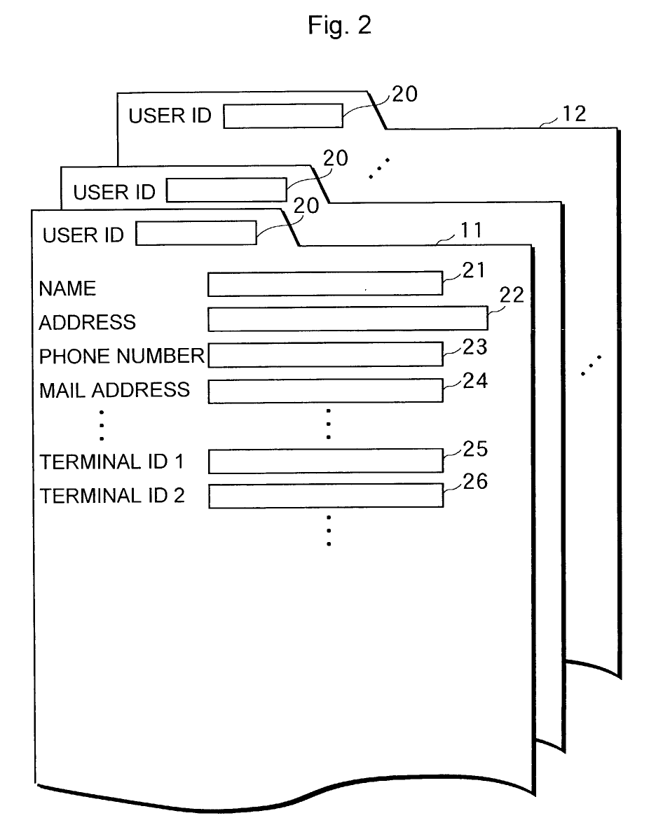

FIG. 2 shows an example data structure of the user information 11˜12 in the user database 51. The user information 11˜12 is produced for each of all the users, including users of the child terminals 7, within the content distribution system, and managed in accordance with user IDs 20. Each set of the user information 11˜12 contains the following: personal information such as a user name 21, an address 22, a phone number 23, and an e-mail address 24; and terminal IDs 25 and 26 used by the user.

The personal information is registered together with at least one terminal ID of the user when the user purchases a content in this content distribution system for the first time. The user information 11˜12 is thereafter updated in accordance with a request from the user for changing the information 11˜12. For instance, such request may be for adding user information since an additional child terminal 7 is installed in the home 3, or changing the address 22 due to moving.

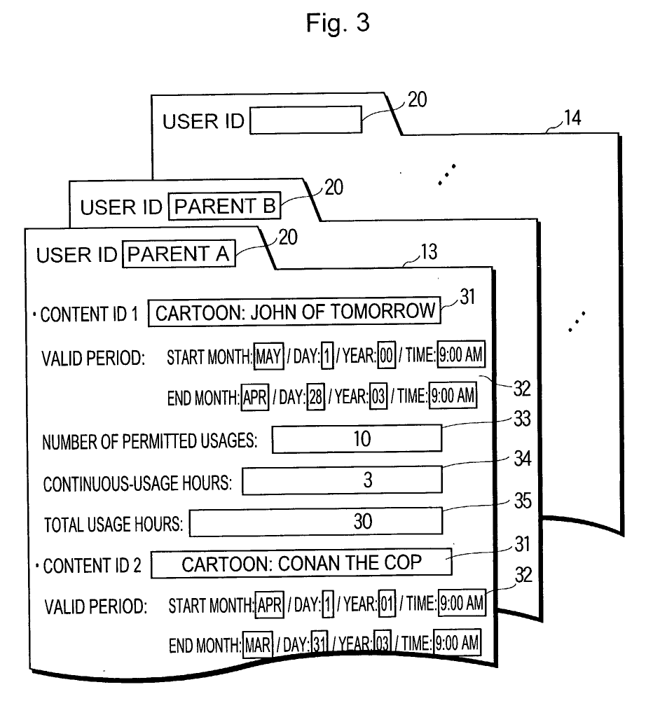

FIG. 3 shows an example data structure of the usage rule information 13˜14 stored in the usage rule database 52. The usage rule information 13˜14 is produced for each user of parent terminals 6 who purchased contents, and managed according to user IDs 20. In this and other figures, each user ID 20 is shown as a user name specified by the user ID 20. Similarly, each content ID 30 is shown as a name of a content specified by the content ID 30. The usage rule information 13˜14 shows, for each user and each content permitted for the user to use, the following information: a content ID 31 of the content; a valid period 32 for which the content is permitted to be used; a number of permitted usages 33 of the content; continuous-usage hours 34 for which continuous use of the content is permitted; and total usage hours 35 for which the content use is permitted.

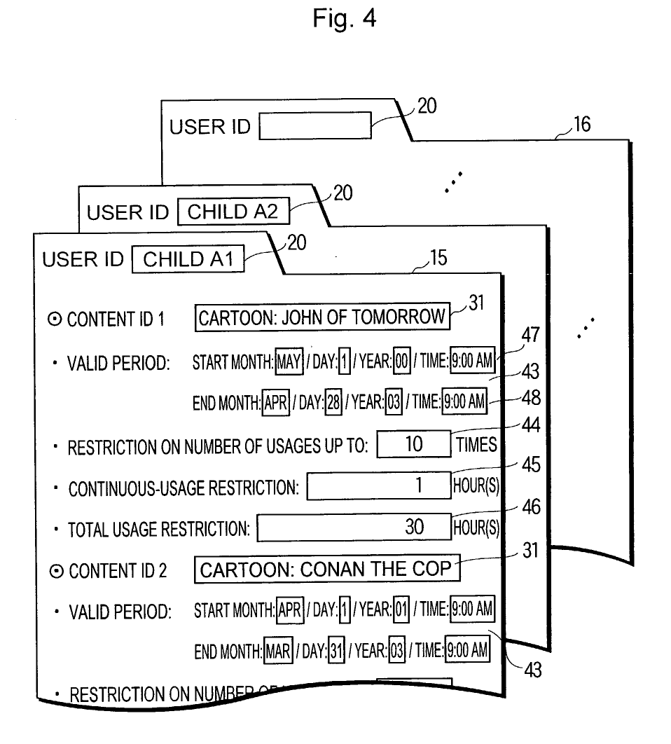

FIG. 4 shows an example data structure of the parental information 15˜16 stored in the parental database 53 shown in FIG. 1. The parental information 15˜16 is produced for each user of child terminals 7, and managed by user IDs 20. The parental information 15˜16 shows, for each child user, a content ID 31 of a content permitted for the user to use, and a plurality of usage restrictions on use of the content. The plurality of usage restrictions include the following: a valid period 43 showing a period for which the user of the child terminal 7 can use the content (for instance, it may be a period of school holidays such as spring/summer recesses); a restriction on the number of usages 44 that restricts the number of content uses by the user; a continuous-usage restriction 45 that restricts the duration of the user's continuous use of the content; and a total usage restriction 46 that restricts a total duration of the user's content use. The valid period 43 consists of a start time 47 and an end time 48 showing the start and the end of the valid period 43.

Different usage restrictions may be set according to a type of each content. For instance, when the content is an on-line video game, the limit on the Internet connection fee may be set as a usage restriction, or a restriction may be placed on a time slot for which the content can be used.

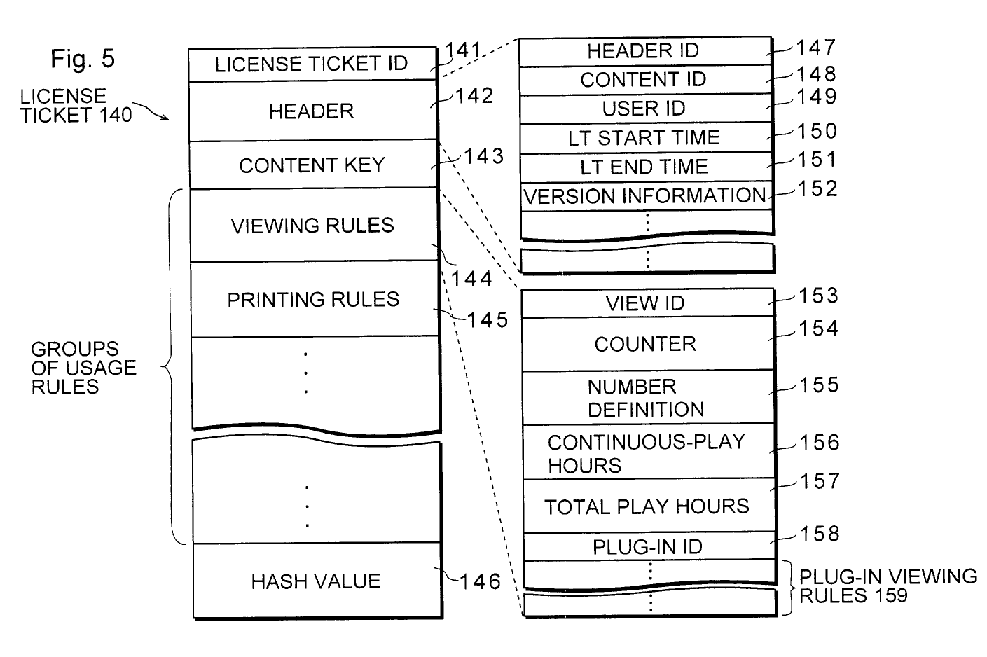

FIG. 5 shows an example data structure of a license ticket 140 issued by the ticket producing unit 54 to the parent terminal 6. The license ticket 140 includes, at the start, a license ticket ID 141 that is a character string identifying the license ticket 140, and also the following information in order: a header 142 containing various information relating to the license ticket 140; a content key 143 for decrypting encryption of a content shown in the ticket 140; groups of usage rules 144, 145 . . . provided in accordance with an operation mode of the content; and a hash value 146 of the ticket 140 at the end of the ticket 140. The above operation mode indicates how the content is used. Out of the above groups of usage rules 144, 145 . . . , a group of usage rules 144 (viewing rules 144) may be rules for viewing the content when the content is images to be viewed. When the content is for printing, another group of usage rules (printing rules 145) may be rules for printing the content. The license ticket 141 may include other groups of usage rules in accordance with other possible usages of the content.

The header 142 includes the following information: a header ID 147 that is a character string identifying the header 142; a content ID 148 that identifies the content used based on this license ticket 140; a user ID 149 that identifies the user who uses the content by using this ticket 140; an LT (license ticket) start time 150 showing a start time of a valid period of this ticket 140 by year, month, day, and time; an LT end time 151 showing an end time of the same valid period by year, month, day, and time; and version information 152 for this content distribution system. Note that the header 142 includes blank fields for storing other information when necessary, such as the terminal ID of a terminal that actually processes the content, to specify this terminal out of a plurality of the user's terminals that are capable of processing the content.

The viewing rules 144 include the following information: a view ID 153 that identifies the entire viewing rules 144; a counter 154 showing a number of times the user is permitted to use the content; a number definition 155 showing how the counter 154 counts the number of times, such as by defining that “playing the content for 10 seconds is counted as one”; continuous-play hours 156 for which the user is permitted to play the content continuously; total play hours 157 for which the user is permitted to play the content; a plug-in ID 158 that is a predetermined character string identifying plug-in viewing rules 159; and the plug-in viewing rules 159 showing rules for viewing the content that are determined uniquely by the plug-in playback module. The plug-in ID 158 and the plug-in viewing rules 159 do not need to be provided in the viewing rules 144 in certain types of the plug-in playback modules.

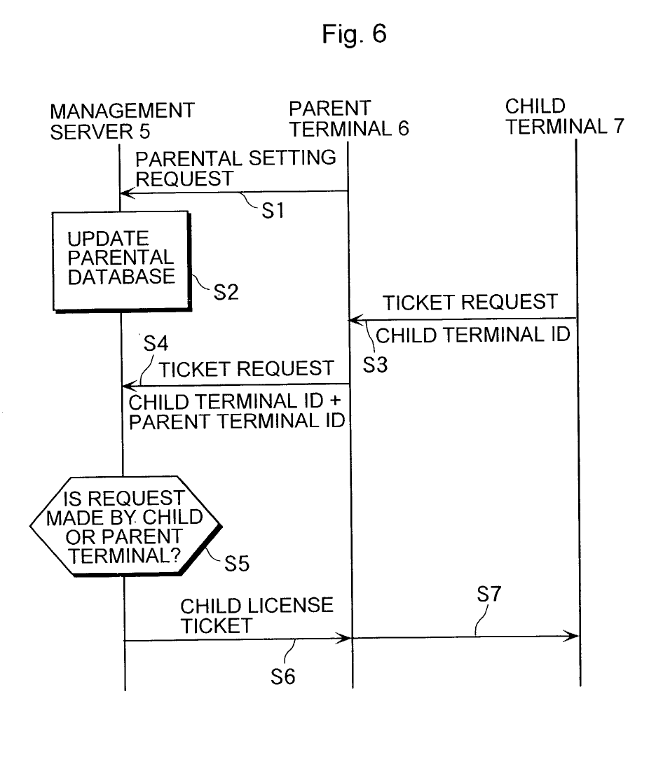

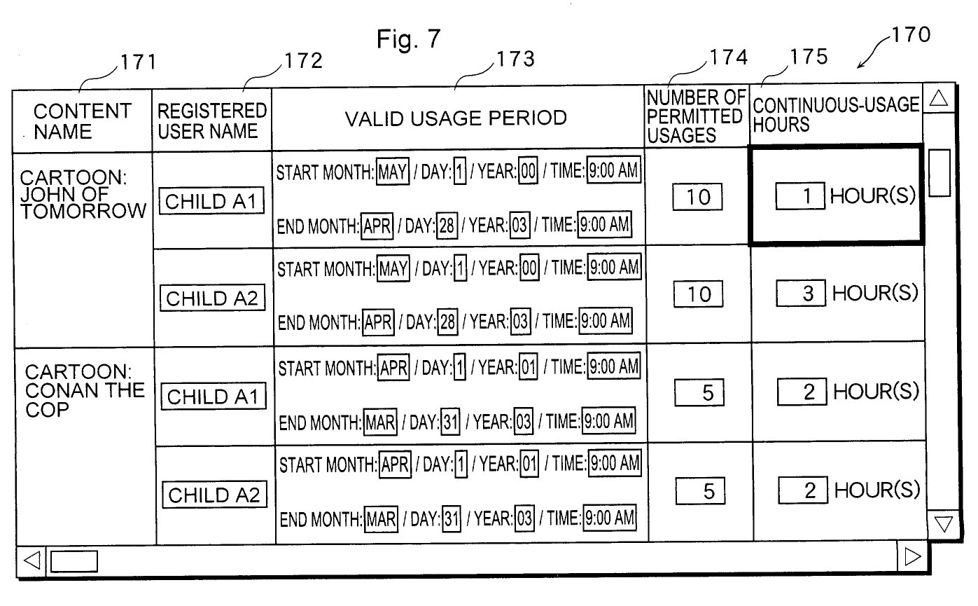

The following describes the operation of the parental system 1 having the above construction with reference to FIG. 6 of a sequence diagram and FIG. 7 showing the parental setting screen.

FIG. 6 is a sequence diagram showing an example procedure of communication between the management server 5, the parent terminal 6, and the child terminal 7. This procedure is for operation of the child terminal 7 to make a content request and use the content on which parental usage restrictions are placed by the parent terminal 6. Prior to this operation, the user of the parent terminal 6 accesses the management server 5 to purchase the content and get a license of the content. The user of the parent terminal 6 then registers the child terminal 7 in the management server 5, makes a request for the parental setting screen to the management server 5, and receives the parental setting screen as shown in FIG. 7. The parent terminal 6 then enters, to the parental setting screen, parental usage restrictions on use of the purchased content, and sends the parental setting request composed of the entered parental usage restrictions to the management server 5 (step S1).

FIG. 7 shows an example of a parental setting screen 170 sent from the management server 5 in response to a request made by the parent terminal 6. The parental setting screen 170 includes items that correspond to items of the usage rule information 13˜14 shown in FIG. 3 and the parental information 15˜16 shown in FIG. 4. More specifically, the parental setting screen 170 includes the following items: a content name 171 showing a name of a content whose use is permitted; a registered user name 172 showing a name of the user of the child terminal 7 permitted to use the content; a valid period 173 that shows the valid period 32 shown in the usage rule information 13˜14 so as to receive an input to restrict this valid period 32; a number of-permitted usages 174 that shows the number of permitted usages 33 shown in the usage rule information 13˜14 so as to receive an input to restrict this number of permitted usages 33; and continuous-usage hours 175 showing the continuous-usage hours 34 so as to receive an input that restricts the hours 34.

For instance, assume that the user, Parent “A”, of the parent terminal 6 has two children, Child “A1” and Child “A2”, who are users of the child terminals 7 and that Parent “A” wants to reduce the continuous-usage hours 34 applied for Child “A1” to view a content “Cartoon: John of Tomorrow” from three hours to one hour because Child “A1” always plays too much without studying. On the other hand, Parent “A” does not place any additional restrictions on Child “A2” who does well at school. Then Parent “A”, viewing the parental setting screen 170, places a cursor on the continuous-usage hours 175 as shown in the figure, and changes the hours 175 from “3” to “1” hour. After this, Parent “A” presses a transmission button provided on an operational unit (not shown in figures) to send this parental restriction as part of the parental setting request to the management server 5.

On receiving this parental setting request, the parental control unit 56 of the management server 5 produces the parental information for each user of the child terminals 7, and updates the parental database 53 (step S2). For the example of FIG. 7, as a result of the parental setting request sent to the management server 5 to restrict the continuous-usage hours 34 to one hour, the continuous-usage restriction 45 on the content “Cartoon: John of Tomorrow” within the parental information 15 for Child “A1” is set as one hour.

After this, Child “A1” operates on the requesting unit 72 of the child terminal 7 for sending a ticket request containing the terminal ID of the child terminal 7 to the parent terminal 6 (step S3), and the parent terminal 6 attaches its terminal ID to the ticket request and sends it to the management server 5 (step S4). More specifically, on receiving a request for a menu screen used for requesting a license ticket from the child terminal 7, the management server 5 sends the menu screen to the child terminal 7 as in the above case of setting the parental information. The child terminal 7 displays this menu screen containing: a name of a content permitted for the user, Child “A1”, of the child terminal 7; and usage rules currently permitted for Child “A1”. Child “A1” viewing this menu screen selects the content “Cartoon: John of Tomorrow” as the desired content, inputs “3 hours” as a desired duration for playing the selected content, so that a ticket request is produced based on the data inputted to the menu screen. The child terminal 7 then attaches its terminal ID to the ticket request, and sends the ticket request containing the content ID of the desired content and usage rules to the parent terminal 6 such as by pressing the transmission button. On receiving the ticket request, the communication unit 63 of the parent terminal 6 attaches its terminal ID to the ticket request, and transfers it to the management server 5.

The parent/child judging unit 55 of the management server 5 receives this ticket request, recognizes that the ticket request containing terminal IDs of both the parent terminal 6 and the child terminal 7, and therefore judges that the ticket request was made by the child terminal 7 (step S5).

In response to this judgment result, the parental control unit 56 reads, from the parental database 53, “1 hour” that is the continuous-usage restriction 45 placed on Child “A1” for use of the requested content “Cartoon: John of Tomorrow”, and sends the read continuous-usage restriction 45, “1 hour”, to the ticket producing unit 54.

The ticket producing unit 54 refers to the terminal ID of the parent terminal 6 attached to the ticket request so as to specify Parent “A” as the user of the parent terminal 6. The ticket producing unit 54 also refers to the content ID contained in the ticket request to specify the content “Cartoon: John of Tomorrow”, and reads usage rule information 13 for the specified content and Parent “A”. As the playback duration “3 hours” requested in the ticket request does not exceed the total usage hours 35 “30 hours” in the read usage rule information 13, the ticket producing unit 54 produces a license ticket responding to the ticket request. The ticket producing unit 54 also updates the read usage rule information 13. In more detail, when the number definition 155 in the license ticket defines, for instance, that “playing a content for three hours is counted as one”, the number of permitted usages 33 shown as “10” is updated to “9” as a result of subtracting “1” for the requested use from “10”. The total usage hours 35 shown as “30 hours” are updated to “27 hours” as a result of subtracting “3 hours” from “30 hours”. At the same time, the ticket producing unit 54 produces the license ticket 140 that corresponds to the requested three-hour content use as follows. The ticket producing unit 54 first produces the viewing rules 144 of the license ticket 140 such as the following: the counter 154 set as “1”; the number definition 155 shown as “playing a content for three hours is counted as one”; the continuous play hours 156 set as “3 hours”; and the total play hours 157 set as “3 hours”. The ticket producing unit 54 then updates the continuous play hours 156 from “3 hours” to “1 hour” in response to the continuous-usage restriction 45 shown as “1 hour” sent from the parental control unit 56. After this, the ticket producing unit 54 attaches a content key for the requested content “Cartoon: John of Tomorrow” to the above parts of the license ticket 140, and writes the user ID of the child terminal 7 in the header 142. This produces the child license ticket. The ticket producing unit 54 then attaches, to the license ticket, the terminal ID of the child terminal 7 as the destination of the ticket, and sends it via the communication unit 57 to the parent terminal 6 (step S6).

On receiving the license ticket, the communication unit 63 of the parent terminal 6 specifies the child terminal 7 by referring to the terminal ID attached to the ticket, and transfers the ticket to the specified child terminal 7 (step S7).

The child terminal 7 receives this license ticket, places it into the content storing unit 74, and decrypts encryption of the content, which has been obtained separately from the ticket, by using the stored ticket. The child terminal 7 plays the content in accordance with the usage rules to which parental usage restrictions are added. Consequently, play of the content “Cartoon: John of Tomorrow” stops one hour after Child “A1” starts the playback of the content, although Child “A1” made the ticket request for three-hour playback.

In the present embodiment, the user of the parent terminal 6 can set different usage restrictions in the above parental information 15˜16 in accordance with each child user and each content. In addition, various types of restrictions can be set in accordance with types of contents. This allows the user of the parent terminal 6 to ease or strengthen the usage restrictions, clear all the restrictions, or select a desired restricting method from a variety of methods in accordance with the growth of each user of the child terminal 7.

Moreover, with the parental system 1 of the first embodiment, the management server 5 stores the parental information 15˜16, produces a license ticket for a child user in accordance with the stored parental information 15˜16, and sends the license ticket to the child user. This reduces the load of the parent terminal 6 and the child terminal 7 in each home 3, so that their constructions can be simplified.

The above embodiment is used to describe the parental system 1 of the present invention, although it should be clear that the present invention is not limited to the above embodiment. For instance, the above embodiment states that the management server 5 issues a license ticket prior to distribution of a content, although this is not necessary. It is alternatively possible, however, to allow a user to receive an encrypted content at any time via the communication network 8 and purchase a license ticket for this content when the user is actually going to use the content.

In the above embodiments, each set of the parental information 15˜16 corresponds to a different user of the child terminal 7, and this set of parental information contains restrictions on the user's use of each of different contents. However, each set of the parental information 15˜16 may correspond to a different content, and this set of parental information may contain restrictions on the content use by each of different users of the child terminals 7. Alternatively, each set of parental information may be produced corresponding to a different terminal ID, instead of a user ID as described in the above embodiment.

The above embodiment is provided on the assumption that that each child terminal 7 is used by a different user. However, the same child terminal 7 may be used by different users. This can be achieved as follows. Such as by presenting a menu screen to a user, the requesting unit 72 of the child terminal 7 requires each user to enter his own user ID 20 whenever he inputs data. The requesting unit 72 then sends a ticket request containing the entered user ID 20 as well as the terminal ID of the child terminal 7. In this case, the parental control unit 56 reads usage restrictions corresponding to the user ID 20 contained in the ticket request from the parental information 15˜16 in the parental database 53, and sends the read usage restrictions to the ticket producing unit 54.

The above embodiment states that the requesting unit 72 of the child terminal 7 attaches the terminal ID of the child terminal 7 to requests of various types and that the communication unit 63 of the parent terminal 6 attaches its own terminal ID to this request when relaying the request to the management server 5. It is alternatively possible, however, to have the requesting unit 72 of the child terminal 7 always send terminal IDs of its own and the parent terminal 6 when making a request since it is clear that the child terminal 7 cannot directly access the management server 5 due to its construction.

In the above embodiment, when the parent and child terminals 6 and 7 send ticket requests for the same content, the management server 5 sends license tickets for the content separately to the parent and child terminals 6 and 7. However, the management server 5 may include a license ticket for the child terminal 7 into a license ticket for the parent terminal 6 after producing two license tickets for the same content separately, and send them to the parent terminal 6. On receiving them, the parent terminal 6 takes the child ticket license out of the parent license ticket and sends the child license ticket to the child terminal 7.

In the above embodiment, the management server 5 writes, into the field for the user ID 149 in the header 142 of the license ticket 140, an ID of a user of either the parent terminal 6 or the child terminal 7 making a ticket request, so that this license ticket 140 (and the usage license as a whole) can be used only by the user specified by the user ID, and therefore becomes user bound. However, it is alternatively possible to provide a field for storing a terminal ID in the header 142 of the license ticket 140 and to write the terminal ID of one of the parent terminal 6 and the child terminal 7 that made the ticket request into this field, instead of writing the user ID into the field of the user ID 149. As a result, the license ticket 140 (and the usage license as a whole) can be used only by the terminal specified by the terminal ID, and therefore becomes terminal bound. In this case, information such as the user information 11˜12, the usage rule information 13˜14, and the parental information 15˜16 are produced corresponding to each terminal ID.

Second Embodiment

The following specifically describes the second embodiment of the present invention with reference to drawings.

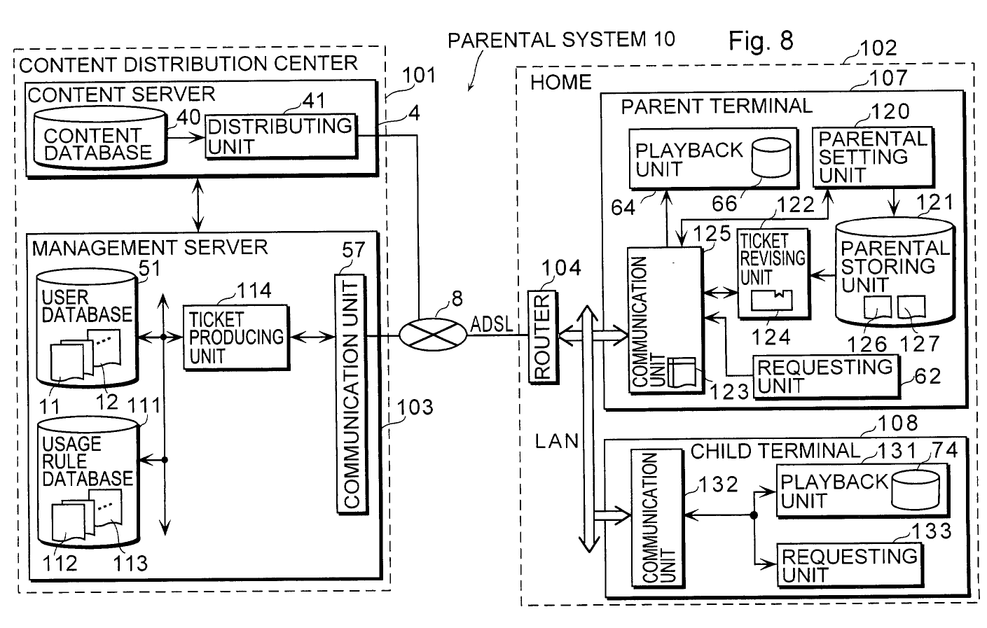

FIG. 8 is a block diagram showing the construction of a parental system 10 of the present second embodiment. In the figure, elements common to the first and second embodiments are assigned the same reference numbers, and will not be described as they have been described in the first embodiment.

Unlike the parental system 1, the present parental system 10 includes child terminals connected to a public network, and has a management server reject direct access from child terminals designated by a parent user to logically cut off the connection to the designated child terminals. A parent terminal in the parental system 10 stores usage restrictions set by a user of the parent terminal in advance, and dynamically updates, in accordance with the stored usage restrictions, a license ticket requested by one of the above child terminals so as to restrict content use by the child terminal. The parental system 10 comprises the following elements: a content server and a management server 103 installed in the content distribution center 101; a communication network 8; and a parent terminal 107, a child terminal 108, and a router 104 that are all installed in each of homes 102 with the router 104 connecting the parent and child terminals 107 and 108 to the communication network 8.

In response to a parental validating request from the parent terminal 107, the management server 103 invalidates usage rules for a user of the child terminal 108 specified by the parental validating request to cut off the direct access from the child terminal 108. The management server 5 is roughly divided into two databases (user database 51 and usage rule database 111) achieved by a hard disk and the like and into two processing units (a ticket producing unit 114 and a communication unit 57) achieved by a program and the like.

The usage rule database 111 stores usage rule information 112˜113 produced by the ticket producing unit 114 for contents.

The usage rule information 112˜113 is basically the same as the usage rule information 13˜14 shown in FIG. 3, but differs from the rule information 13˜14 in that each set of the rule information 112˜113 is produced for each user of the child terminals 108 as well and in that each set of the information 112˜113 includes a flag region 81 (described later) for storing a flag to show whether the set of usage rule information for the user is valid. When the flag is on, the set of usage rule information is invalid. The usage rule information is valid when the flag is off.

In response to the parental validating request from the parent terminal 107, the ticket producing unit 114 sets the flag in a flag region 81 of a set of usage rule information corresponding to a user of a child terminal 108 specified by the parental validating request. As a result, this set of usage rule information is shown as being invalid. On thereafter receiving a ticket request from the child terminal 108, the ticket producing unit 114 refers to the user information 11˜12 and a terminal ID contained in the ticket request to specify the user ID 20 of the user of the child terminal 108, and then specifies the set of usage rule information for the specified user out of the usage rule information 112˜113. Following this, the ticket producing unit 114 refers to the flag region 81 of the specified set of usage rule information. If the flag is on, the ticket producing unit 114 sends a message notifying the requesting child terminal 108 that the license ticket 140 can be issued only when the ticket request is made via the parent terminal 107. The ticket producing unit 114 then logically cuts off connection between the management server 103 and the child terminal 108. When the flag is not set in the flag region 81, the ticket producing unit 114 issues, regardless of whether the request is made by the parent terminal 107 or the child terminal 108, the license ticket 140 as performed by the ticket producing unit 54 of FIG. 1. In response to a parental invalidating request from the parent terminal 107, the ticket producing unit 114 clears the flag in the flag region 81 for a user of the child terminal 108 specified by the parental invalidating request.

The router 104 is a communication device that connects the parent and child terminals 107 and 108, which are connected to each other with LAN, to the external communication network 8 such as ADSL.

The parent terminal 107 is a computer, such as a PC, purchased for use by a parent of each of the homes 102. Once the management server 103 rejects a ticket request from the child terminal 108, the parent terminal 107 makes the ticket request for the child terminal 108. On receiving the license ticket 140 responding to this ticket request, the parent terminal 107 adds, to usage rules shown in the license ticket 140, usage restrictions set beforehand by the user of the parent terminal 107 for the child terminal 108, and transfers this license ticket to the child terminal 108.

The parent terminal 107 is roughly divided into four storing units achieved by a hard disk and the like and into five processing units achieved by a program and the like. The four storing units consist of a content storing unit 66, a parental storing unit 121, a request history storing unit 123, and a residual ticket storing unit 124. The five processing units consist of a requesting unit 62, a playback unit 64, a parental setting unit 120, a ticket revising unit 122, and a communication unit 125.

The parental setting unit 120 presents a parental setting screen to the user to receive the user's input, and produces parental information 126 based on the user's input in a similar way to the parental setting unit 61 shown in FIG. 1. The present parental setting unit 120 differs from the setting unit 61 in the following three aspects. First, the parental setting unit 120 stores the produced parental information 126 in the parental storing unit 121. Secondly, the parental setting unit 120 sends the parental validating request via the communication unit 125 to request the management server 103 to cut off direct access from the user of the child terminal 108 designated by the parent user. Thirdly, the parental setting unit 120 receives user input of restriction easing information 127 to be set for a child terminal 108. The restriction easing information 127 shows information that eases usage restrictions on the content use under a certain condition if the residual ticket storing unit 124 stores a “residual license ticket” (described later).

The parental storing unit 121 stores the parental information 126 produced by the parental setting unit 120, and the restriction easing information 127.

The ticket revising unit 122 stores a correspondence between terminal IDs of terminals in the home 102 and user IDs of users of these terminals. On receiving the license ticket 140 to which the terminal ID of the child terminal 108 is attached from the communication unit 125, the ticket revising unit 122 changes the user ID of the requesting user, which is written in the header of the license ticket, into the user ID of the child terminal 108. The ticket revising unit 122 then refers to the parental information 126 in the parental storing unit 121, and writes, in the header of the received license ticket 140, usage restrictions set in the parental information 126 for the user of the child terminal 108 to revise the license ticket 140 for the child terminal 108. The ticket revising unit 122 then sends the revised license ticket to the communication unit 125.

In more detail, the ticket revising unit 122 revises information in the header 142 of the license ticket 140 shown in FIG. 5 as follows. The ticket revising unit 122 writes the start time 47 (shown in FIG. 4) of the valid period 43 for a content as the LT start time 150, and also writes the end time 48 of the valid period 43 as the LT end time 151. In this way, the ticket revising unit 122 writes the valid period 43 for the content as the valid period for the license ticket 140, so that the content is used by the child terminal 108 in accordance with the revised valid period for the license ticket 140 even when the valid period for the content is written in such fields as viewing rules 144 and printing rules 145.

The ticket revising unit 122 also subtracts values representing the revised usage rules shown in the above revised license ticket 140 from values representing the original usage rules shown in the originally received license ticket, and produces the aforementioned residual license ticket that enables use of the content within a usage range represented by values obtained through the subtraction. The ticket revising unit 122 then places the produced residual license ticket into the residual ticket storing unit 124.

On receiving an extra ticket request from the child terminal 108 via the communication unit 125, the ticket revising unit 122 checks whether the residual ticket storing unit 124 stores a residual license ticket for a content requested by the extra ticket request. If so, the ticket revising unit 122 refers to the parental storing unit 121 to judge whether a playback state and other information of the playback unit 131 of the requesting child terminal 108 matches with conditions shown in the restriction easing information 127. The above playback state and the like are shown in the extra ticket request. If they match, the ticket revising unit 122 produces, from the residual license ticket stored in the residual ticket storing unit 124, an extra license ticket that only permits content playback under conditions shown in the restriction easing information 127, and sends the produced extra license ticket to the communication unit 125. From the above residual license ticket, the ticket revising unit 122 also produces a new residual license ticket showing usage rules represented by values from which values representing usage rules of the above extra license ticket have been subtracted. The ticket revising unit 122 then places the new residual license ticket into the residual ticket storing unit 124 to update the ticket storing unit 124.

On the other hand, when the residual ticket storing unit 124 does not store the residual license ticket for the content requested by the extra ticket request, or when the playback state and other information of the playback unit 131 do not match with conditions shown in the restriction easing information 127, the ticket revising unit 122 discards the extra ticket request it has received.

On receiving a ticket request other than an extra ticket request, the ticket revising unit 122 sends the ticket request back to the communication unit 125, which then sends it to the management server 103.

The request history storing unit 123 stores a history of various types of requests. This history is recorded by the communication unit 125 and includes information such as a sending date on which each request is sent, a type of the request, a terminal ID of a terminal that made the request, and a content ID of a content requested by the request.

The residual ticket storing unit 124 stores the residual license ticket produced by the ticket revising unit 122. As is described above, the residual license ticket enables use of a content for a period obtained by subtracting the valid period shown in the revised license ticket for the child terminal 108 from the valid period shown in this license ticket before revision.

The communication unit 125 is connected to the child terminal 108 and the router 104 with LAN. Whenever receiving a content request from the communication unit 132 of the child terminal 108, and a content request and a ticket request from the requesting unit 62 of the parent terminal 107, the communication unit 125 writes the history of each request into the request history storing unit 123, and sends these requests to the management server 103. When receiving a ticket request from the child terminal 108, the communication unit 125 transfers the request to the ticket revising unit 122, and writes the history of the request into the request history storing unit 123 only when the ticket revising unit 122 returns the ticket request. After this, the communication unit 125 changes the terminal ID of the child terminal 108 written as the requesting terminal in the ticket request to the terminal ID of the parent terminal 107, and sends this ticket request to the management server 103.

When receiving a content and the license ticket 140 from the management server 103 in response to requests, the communication unit 125 refers to the history in the request history storing unit 123 and a terminal ID contained in the received data to specify a requesting terminal, sends the content or the license ticket 140 to the playback unit of the specified terminal, and then deletes the history of the request for the content or the license ticket 140 from the request history storing unit 123.

Note that when the communication unit 125 receives the license ticket 140 responding to a ticket request from the child terminal 108, the communication unit 125 does not directly send the license ticket 140 to the playback unit 131 of the requesting child terminal 108. Before doing so, the communication unit 125 attaches the terminal ID of the child terminal 108 to the license ticket 140, transfers the ticket 140 to the ticket revising unit 122, receives the ticket 140 that has been revised from the revising unit 122, and then transfers the revised ticket 140 to the playback unit 131 of the child terminal 108.

The parental information 126 is basically the same as the parental information 15˜16 shown in FIG. 4, and is provided for each child user in the homes 3. The parental information 126 includes a pointer to the restriction easing information 127 if the information 127 corresponding to the information 126 exists.

The restriction easing information 127 includes conditions for easing a restriction on content use, and a description of how such restriction is eased. The restriction easing conditions specifically include the following: a type of a content for which the restriction is eased; a type of the restriction to be eased; a duration between the start of content playback by the playback unit 131 and issuance of an extra ticket request corresponding to the content; and a playback state of the playback unit 131. For instance, assume that the valid period 43 (shown in FIG. 4) is placed as a restriction on a content of a video game, and that the requesting unit 133 is set to make an extra ticket request 10 minutes before the end time 48 of the valid period 43. Then the restricting easing information 127 shows, for instance, that “the end time 48 is extended by 10 minutes (i.e., the description of how the restriction is eased) unless 30 minutes or more time has passed since the start of the content use and if the user's game record has not been saved (i.e., the restriction easing conditions)”.

The child terminal 108 is a computer, such as a PC, purchased for use by a child of a family in each home 102, and is connected via the router 104 to the communication network 8.

In more detail, after the management server 103 logically cuts off its connection to the child terminal 108, the terminal 108 plays a content according to the revised license ticket. Before the connection to the management server 103 is cut off, the child terminal 108 directly sends, to the management server 103 via the router 104 and the communication network 8, a ticket request containing data inputted by the user via the requesting unit 133. From the management server 103, the child terminal 108 receives the license ticket 140 like the ticket issued to the parent terminal 107, and plays the content sent from the content server 4.

The child terminal 108 includes a content storing unit 74 achieved by a hard disk and the like, and three processing units (the playback unit 131, the communication unit 132, and the requesting unit 133) achieved by a program and the like.

The playback unit 131 contains a playback module with a tampering-resistant mechanism, such as an MPEG decoder, and plays a content in a similar way to the playback unit 71 shown in FIG. 1. The present playback unit 131 differs from the playback unit 71 in that the playback unit 131 plays the content in accordance with a valid period written by the ticket revising unit 122 into the header of the revised license ticket while ignoring other usage rules set for the content.

The communication unit 132 is connected with LAN to the parent terminal 107 and the router 104. After the connection between the management server 103 and the child terminal 108 is logically cut off, the communication unit 312 performs basically the same operation as the communication unit 73 shown in FIG. 1. The communication unit 132 differs from the communication unit 73 in the following operations that the unit 132 performs before its connection to the management server 103 is logically cut off. That is to say, the present communication unit 132 directly sends, to the management server 103 via the router 104 and the communication network 8, a ticket request and a content request that contain data inputted by the user via the requesting unit 133, and receives the license ticket 140 like the ticket received by the parent terminal 107 from the management server 103 and the requested content from the content server 4.

The requesting unit 133 receives a screen such as a menu screen from the management server 103 in response to a request designated through user's inputs, presents the screen to the user to receive the user's inputs, and sends, to the management server 103 via the communication unit 132, various types of requests composed of the user's inputs, such as a content request and a ticket request. At the same time, the requesting unit 133 sends the terminal ID of the child terminal 108 to specify the requesting terminal 108. The requesting unit 133 differs from the requesting unit 62 of the parent terminal 107 in that the unit 133 performs the following operations. That is to say, the requesting unit 133 always monitors the playback state of the playback unit 131, and presents, with a predetermined timing, a message notifying the user that the playback of a currently played content is discontinued in certain minutes due to usage rules written in the license ticket if such information is written in the ticket. At the same time, the requesting unit 133 sends an extra ticket request showing the above playback state of the content to the communication unit 132. This extra ticket request contains ID information showing that this request is for the extra license ticket.

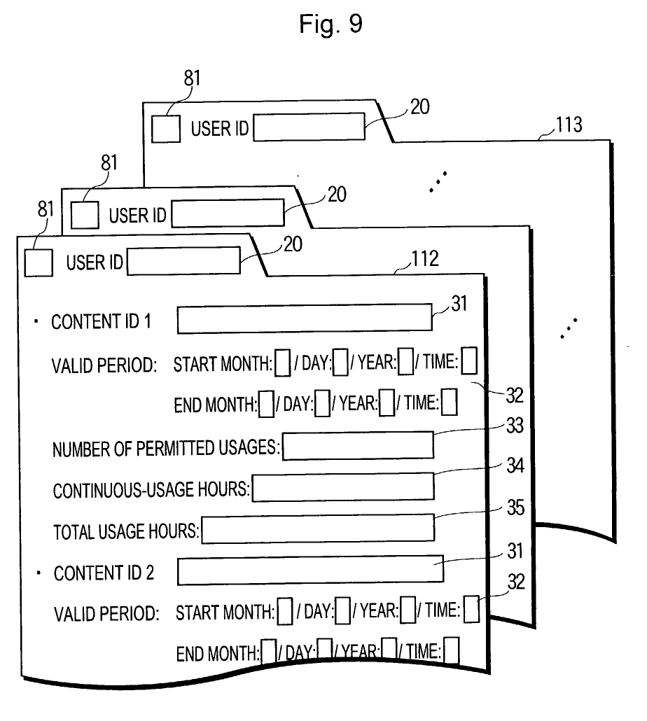

FIG. 9 shows usage rule information 112˜113 stored in the usage rule database 111 shown in FIG. 8. Unlike the usage rule information 13˜14 shown in FIG. 3, the present usage rule information 112˜113 is produced for all the users including users of the child terminals 108, and each set of the usage rule information 112˜113 includes a flag region 81. When a flag is set in the flag region 81, the set of usage rule information is recognized as rule information for a user of a child terminal 108 and as being invalidated by a parental validating request from the parent terminal 107.

When the flag is not set in the flag region 81, the child terminal 108 is allowed to directly make a ticket request to the management server 103, receive the license ticket 140, and use the content.

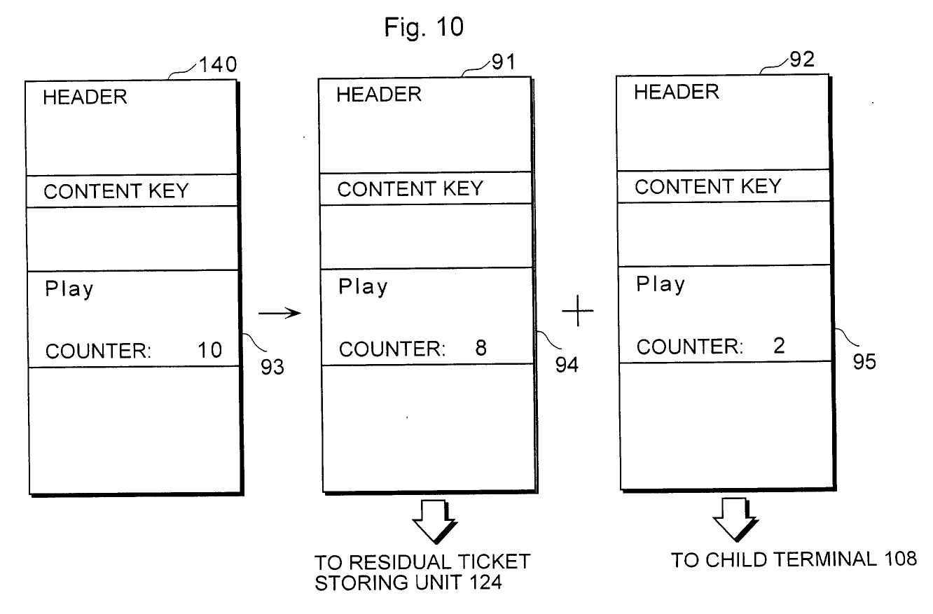

FIG. 10 shows, as an example, how the ticket revising unit 122 revises a license ticket. The figure shows a license ticket 140 sent from the management server 103, a residual license ticket 91, and a revised license ticket 92 for a child user.

As shown in the figure, the license ticket 140 contains a usage rule 93 that permits playback of the content ten times. When the parental information 126 for the user of the child terminal 108 stored in the parental storing unit 121 contains a usage restriction that restricts the number of playbacks of the content to two, the ticket revising unit 122 changes the usage rule 93 permitting ten playbacks into a usage rule 95 permitting only two playbacks to produce the revised license ticket 92 for the child user. As a result, the usage right for eight-time playbacks remains after two-time playbacks for the revised ticket 95 are subtracted from ten-time playbacks of the original ticket 140. If no operation is performed here for the remaining usage right, the usage right becomes invalidated. The ticket revising unit 122 therefore produces the residual license ticket 91 containing a usage rule 94 permitting the remaining eight-time playbacks of the content, and updates the residual ticket storing unit 124.

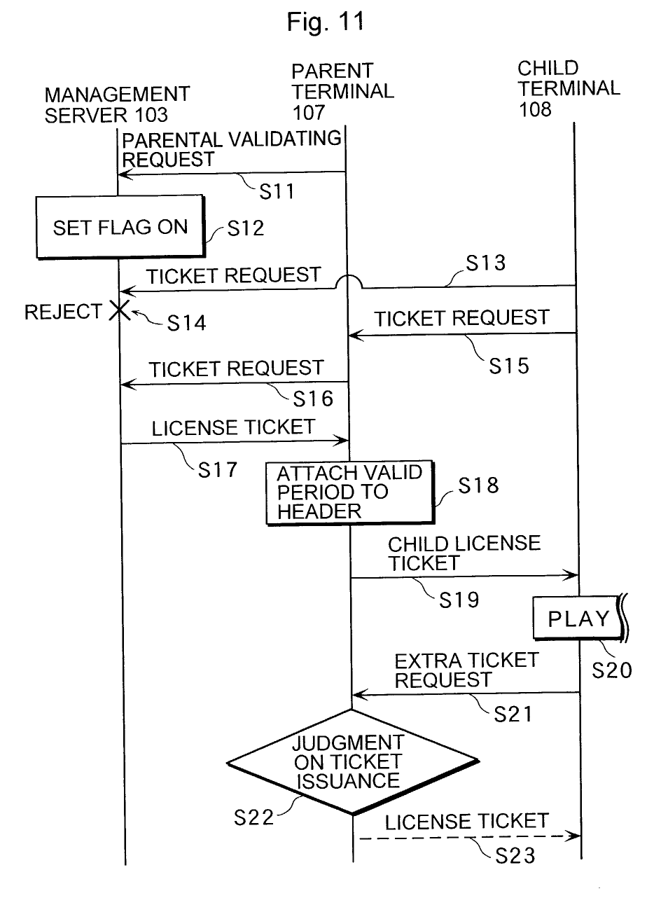

FIG. 11 is a sequence diagram showing an example procedure by which the management server 103, the parent terminal 107, and the child terminal 108 communicate with one another to have the child terminal 108 make a ticket request and obtain a content on which parental usage restrictions are placed.

The parent terminal 107 sends, to the management server 103, a parental validating request that designates a user of the child terminal 108 for whom content usage restrictions should be placed (step S11).

The ticket producing unit 114 sets a flag in a flag region 81 within the usage rule information 112˜113 for the designated user so as to invalidate usage rules written in the usage rule information 112˜113 for the user (step 512).

The child terminal 108 sends a ticket request to the management server 103 (step S13), so that the ticket producing unit 114 refers to the user information 11˜12 and the terminal ID attached to the sent ticket request to specify a user ID corresponding to the terminal ID. The ticket producing unit 114 then refers to the usage rule information 112˜113 to specify usage rule information corresponding to the specified user ID, and recognizes that a flag is set in the flag region 81 of the specified usage rule information. The ticket producing unit 114 therefore rejects the ticket request from the child terminal 108 (step S14).

As a result, the child terminal 108 is now allowed to make a ticket request only by sending the ticket request via the parent terminal 107 to the management server 103. The child terminal 108 thereafter sends a ticket request to the parent terminal 107 (step S15).

The parent terminal 107 changes the terminal ID of the requesting child terminal 108 attached to the above ticket request into the terminal ID of the parent terminal 107, and sends the ticket request as its own request to the management server 103. At the same time, the parent terminal 107 writes, into the request history storing unit 123, the content ID of the requested content and the terminal ID of the child terminal 108 originally making the ticket request (step S16).

The management server 103 receives the ticket request from the parent terminal 107, and issues a license ticket 140 (step S17).

The communication unit 125 of the parent terminal 107 receives the license ticket 140 from the management server 103, and refers to the request history storing unit 123 and the content ID shown in the ticket 140 to specify the child terminal 108 that originally made the ticket request. The communication unit 125 attaches the terminal ID of the specified child terminal 108 to the license ticket 140, and sends it to the ticket revising unit 122. The ticket revising unit 122 changes a user ID written in the license ticket 140 into the user ID of the child terminal 108 that originally made the ticket request. After this, the ticket revising unit 122 refers to the parental storing unit 121 to specify a valid period 43 (consisting of a start time 47 and an end time 48) corresponding to the user ID of the child terminal 108 and to the content ID shown in the license ticket 140. The ticket revising unit 122 writes the specified valid period 43 into the header of the license ticket 140 to produce a revised license ticket for the child terminal 108 (step S18), and sends the revised license ticket to the child terminal 108 via the communication unit 125 (step S19).

The child terminal 108 decrypts encryption of the content, which has been obtained separately from the license ticket 140, by using a content key contained in the revised license ticket, and plays the content in accordance with the valid period 43 written in the header of the license ticket 140 (step S20).

When the end time 48 of the valid period 43 approaches during content playback by the child terminal 108, the requesting unit 133 monitoring the playback state of the playback unit 131 sends an extra ticket request containing data showing the monitored playback state to the parent terminal 107 (step S21).

The communication unit 125 of the parent terminal 107 transfers this extra ticket request to the ticket revising unit 122, which then checks whether the residual ticket storing unit 124 stores a residual license ticket corresponding to the extra ticket request. When the residual ticket storing unit 124 stores the residual license ticket, the ticket revising unit 122 refers to the restriction easing information 127 in the parental storing unit 121 to judge whether information shown in the extra ticket request matches with conditions written in the restriction easing information 127 (step S22). If so, the ticket revising unit 122 produces from the above residual license ticket an extra license ticket that permits use of the content under the conditions written in the restriction easing information 125. The ticket revising unit 122 then writes the user ID of the user of the child terminal 108 into the extra license ticket, and attaches the terminal ID of the child terminal 108 as the destination to the extra license ticket. Following this, the ticket revising unit 122 transfers the extra license ticket to the communication unit 125, which then transfers it to the child terminal 108 specified by the terminal ID attached to the extra license ticket (step S23). This extra license ticket enables the user of the child terminal 108, for instance, to continue to play the game until he reaches the stage of the game in which he can save his game record, although the game would be discontinued without saving his record if such extra license ticket is not issued.

As has been described, the user of the above parent terminal 10 can set different usage restrictions in the parental information 126 in accordance with each child user and each content used by the child user. In addition, various types of restrictions can be set in accordance with types of contents. This allows the user of the parent terminal 6 to ease and strengthen restrictions on content use by a child user, clear all the restrictions, and select a desired restricting method from a variety of methods in accordance with growth of each child user of the child terminal 7.

Moreover, as the parent terminal 107 dynamically produces a license ticket for the child terminal 108, not only the load of the management server 103 can be reduced, but also each license ticket can be specifically designed for each child terminal 108 in the home 102.

Furthermore, with the present parental system 10, restrictions on content use by the child terminal 108 can be temporarily eased under a certain condition, which allows the parent user to place restrictions flexibly with consideration for the state of each child using the content.

The following specifically describes example modifications to child license ticket production of the second embodiment by the ticket revising unit 122 with reference to drawings.

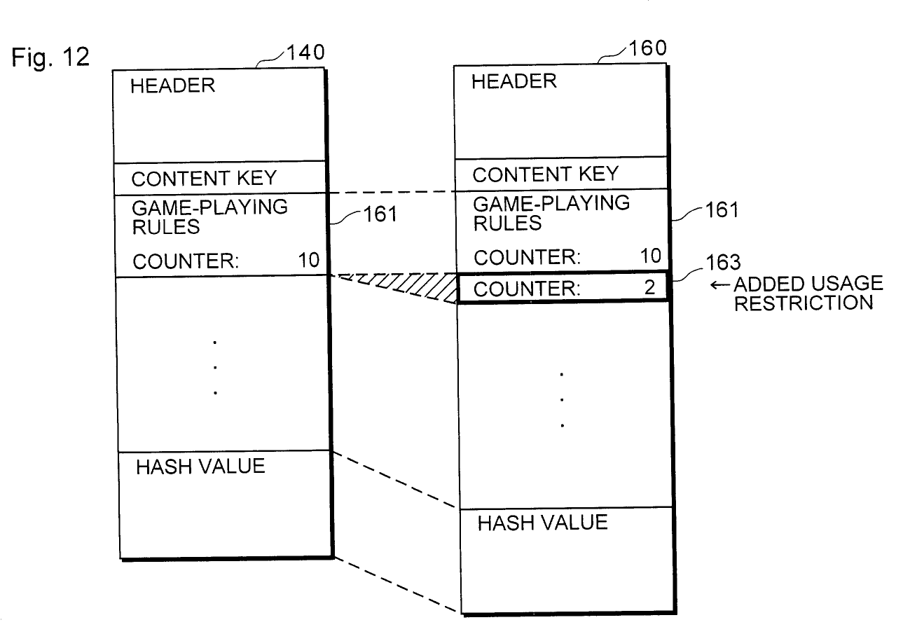

FIG. 12 shows how the ticket revising unit 122 produces a revised license ticket 160 for the child terminal 108 according to the first example modification. The figure shows a license ticket sent from the management server 103 and the revised license ticket 160.

When the license ticket 140 is issued for enabling playing of a game content, for instance, a counter 161 within game-play rules for the content is shown as “10”, which indicates that the content is permitted to be played ten times.

Here, assume that the parental information 126 in the parental storing unit 121 stores a usage restriction 163 that restricts the number of plays of the content to two. Then a ticket revising unit inserts this usage restriction 163 immediately after the field of the counter 163 to produce the revised license ticket 160. This makes the revised license ticket longer by the length corresponding to the inserted usage restriction 163.

This requires the user to set the playback unit 131 so as to make it play the content in accordance with not the counter 161 but the usage restriction 163 inserted after the counter 161.

The revised license ticket 160 produced according to the first example modification differs from the revised license ticket produced by the ticket revising unit 122 in the second embodiment in that the license ticket 160 is produced by changing data length and structure of the original license ticket 140. The original license ticket 140 can be revised in this and other various manners when ticket revision is performed by the parent terminal 107 within the home 102 and the revised license ticket 160 is used only in the home 102 as in the parental system 10 of the second embodiment. Note that the ticket revising unit 122 can revise the original license ticket 140 in such a way as to restrict a usage range shown in usage rules of the original license ticket 140, but cannot revise the original license ticket 140 to enlarge this usage range.

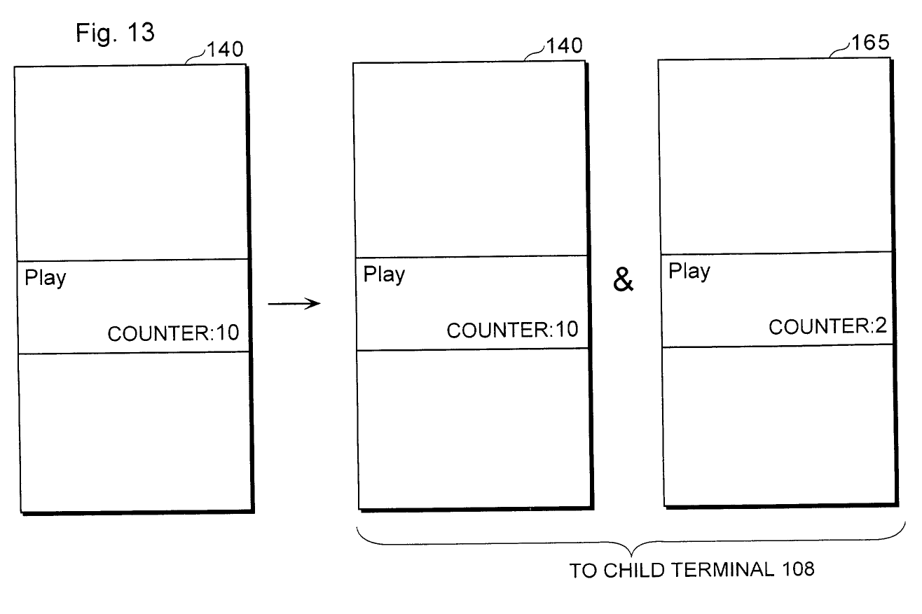

FIG. 13 shows how a restriction ticket 165 is produced by a ticket revising unit according to the second example modification. The license ticket 140 on the left side of the figure is sent from the management server 103 and is the same as the license ticket 140 in the center of the figure. The restriction ticket 165 is a license ticket containing usage restrictions written in the parental information 126. For the second example modification, the license ticket 140 and the restriction ticket 165 are sent as revised license tickets to the child terminal 108.

On receiving the license ticket 140 from the management server 103, the ticket revising unit does not add any revisions to this original license ticket 140, and produces the restriction ticket 165 that has a similar structure to the license ticket 140. This restriction ticket 165 stores, in its fields of usage rules, usage restrictions of the parental information 126 that corresponds to the usage rules. Other fields of the restriction ticket 165 store the same information as the fields of the license ticket 140. For producing the restriction ticket 165, the ticket revising unit makes a copy of the license ticket 140, and revises usage rules, which are written in the copy of the license ticket 140 and which correspond to the usage restrictions in the parental information 126, to usage rules to which these usage restrictions are added.

On receiving the license ticket 140 and the restriction ticket 165, the playback unit of the child terminal finds a logical product (content use permitted up to twice) of a usage rule (permitting content use up to ten times) of the license ticket 140 and a usage rule (permitting content use up to twice) of the restriction ticket 165, and uses the found logical product as the usage rule for playing the content.

For the above example modification, the restriction ticket 165 is described as having basically the same structure as the license ticket 140. However, the structure of the restriction ticket 165 is not limited to this as long as the restriction ticket 165 contains each usage restriction of the parental information 126 as valid information while showing a correspondence between such usage restrictions and usage rules of the license ticket 140. It is not necessary for the restriction ticket 165 to have a structure to be used on its own. For instance, the restriction ticket 165 may only show restrictions to be added to usage rules written in the license ticket 140. The playback unit of the child terminal may find a logical product of usage rules shown by the restrictions of such restriction ticket 165 and usage rules of the license ticket 140.

The license ticket 140 and the restriction ticket 165 of the second example modification may be sent to the child terminal at the same time or different times. In the latter case, the child terminal is set to play a content only when receiving the above two types of license tickets 140 and 165 for the same content. It is alternatively possible to provide the license ticket 140 with information showing whether the restriction ticket 165 is necessary to play the content, so that the child terminal refers to this information and waits until it receives the restriction ticket 165 if necessary, or otherwise plays the content by using the license ticket 140 alone.

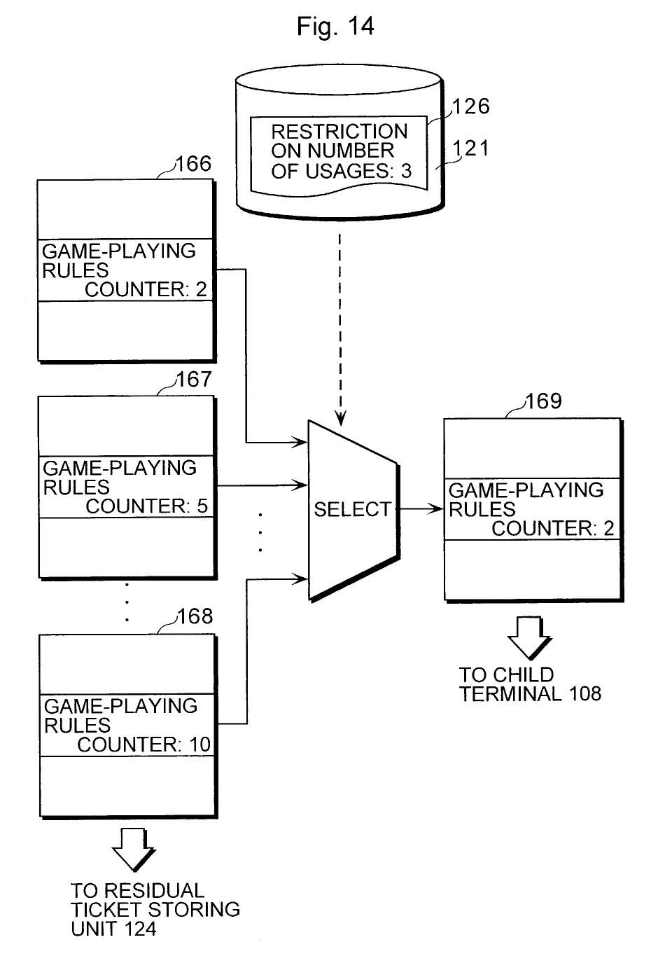

FIG. 14 shows how a license ticket for the child terminal is produced by a ticket revising unit according to the third example modification. Shown on the left side of the figure are license tickets 166˜168 that contain different usage rules and that are sent from the management server 103 to the child terminal. Shown on the right side of the figure is a license ticket 169 that has been selected from tickets 166˜168.

Unlike the embodiments described above, the ticket revising unit of the third example modification produces the license ticket 169 for the child terminal without revising license tickets sent from the management server 103. As shown in the figure, the ticket revising unit receives a plurality of license tickets 166˜168 that show different usage rules for the same content, and places them into the residual ticket storing unit 124. The license ticket 166 contains, in the counter field for the game-playing rules, a usage rule permitting playing the content twice, for instance. Similarly, the license tickets 167 and 168 show usage rules permitting playing the content five times and ten times, respectively.

On receiving a ticket request form the child terminal 108, the ticket revising unit refers to the parental information 126 in the parental storing unit 121 to find a usage restriction placed for the user of the requesting child terminal 108. The ticket revising unit then selects, from the license tickets 166˜168 in the residual ticket storing unit 124, a license ticket containing a usage restriction closest to the found usage restriction that permits playing the content three times. The ticket revising unit therefore selects the license ticket 166 permitting playing the content twice, and sends the selected license ticket 166 as the ticket 169 for the child user to the child terminal 108.

In the second embodiment, usage rule information 112˜113 include a flag region 81 to set a flag to show a child terminal 108 designated by the parental validating request. It is alternatively possible, however, to write information specifying such designated child terminal 108 into the user information 11˜12 or into another database.

The second embodiment states that the ticket revising unit 122 discards an extra ticket request when no residual tickets are stored. However, it is alternatively possible for the ticket revising unit 122 to issue, in response to the extra ticket request, an extra license ticket that only permits a content use within a range shown in the restriction easing information 127 if information in the extra ticket request matches with the restriction easing condition in the restriction easing information 127.

In the first and second embodiments, the management server 5 and the parent terminal 107 restrict content use by the child terminal 7/108 by adding usage restrictions based on the parental information 15˜16/126 to the license ticket 140. However, content use by the child terminal 7/108 may be restricted according to other methods. This can be achieved, for instance, by providing a signal or a command to stop playback of the playback unit 71/131 of the child terminal 7/108 so that this signal or a command can be recognized within the parental system 1/10 or between parent and child terminals. When the user has the parent terminal 6/107 output this signal or the command, playback by the playback unit 71/131 is paused or stopped.

The second embodiment describes a usage license of a content and the license ticket 140 as being user bound. However, the usage license and the license ticket 140 may be issued for each terminal, instead of each user, to make the license and the license ticket “terminal bound.” This can be achieved by providing, in the header of the license ticket 140, a field for storing at least one terminal ID of the parent and child terminals 107 and 108 and by writing the terminal ID into this field, instead of writing a user ID of a user who made the ticket request into the header.

The following describes an example modification to a parental control method used by a parent terminal 107 of the second embodiment with reference to drawings. The user of the parent terminal 107 registers beforehand all the child terminals 108 connected to this parent terminal 107 in a child terminal list. After this registration, the parent terminal 107 places parental usage restrictions on each of the registered child terminals 108. The above child terminal list is stored in a request history storing unit 123 of a communication unit 125, for example.

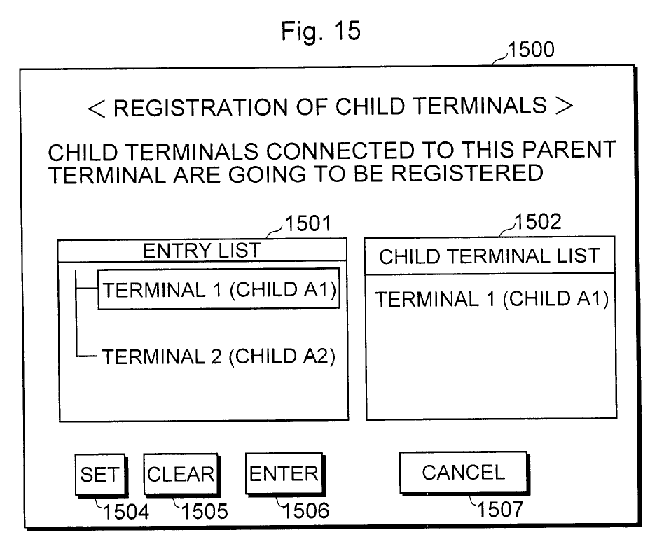

FIG. 15 shows an example of a child terminal registration screen 1500 displayed by the parent terminal 107. As shown in the figure, the child terminal registration screen 1500 includes an entry list 1501 and a child terminal list 1502. The communication unit 125 of the parent terminal 107 automatically detects each child terminal 108 connected to the parent terminal 107 with LAN within the home, for instance, and displays information on the detected child terminals 108 in the entry list 1501. For instance, the entry list 1501 contains two list entries, “Terminal 1 (Child A1)” and “Terminal 2 (Child A2)”. Of the list entry “Terminal 1 (Child A1)”, “Terminal 1” is a terminal name given by the parent terminal 107 to a child terminal 108 with the terminal ID “USO086” presented by the parent terminal 107 to its user. “Child A1” is a user name registered beforehand by a child user in the child terminal 108 with the terminal ID “USO086”. Similarly, of the other list entry “Terminal 2 (Child A2)”, “Terminal 2” is a terminal name presented by the parent terminal 107 to specify another child terminal 108 with the terminal ID “USO871”, and “Child A2” is a user name that has been registered beforehand by a child user of this child terminal 108.

The parent user selects, from the entry list 1501, list entries of child terminals 108 for which the parent user wishes to place content usage restrictions, and registers the selected list entries in the child terminal list 1502. For instance, the parent user selects a list entry of a child terminal 108 displayed in the entry list 1501 by using a controller and the like, and presses a “Set” button 1504. As a result, the selected list entry, “Terminal 1 (Child A)” in the case of the figure, is displayed and registered in the child terminal list 1502. When the user also selects the other list entry “Terminal 2 (Child A2)” in the entry list 1501 and presses the “Set” button 1504, the selected list entry “Terminal 2 (Child A2)” is also displayed and registered in the child terminal list 1502. After this, when the user presses an “Enter” button 1506, the two list entries registered in the child terminal list 1502 are stored in the request history storing unit 123. When the user presses a “Cancel” button 1507, on the other hand, the list entries in the child terminal list 1502 are cleared, and display of the child terminal registration screen 1500 is terminated.

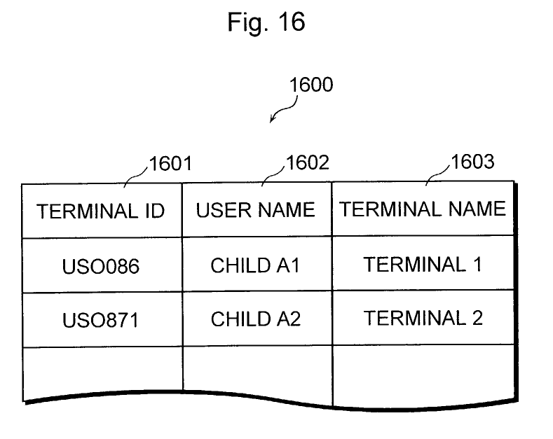

FIG. 16 shows an example of a child terminal list 1600 based on the entries to the child terminal registration screen 1500 and stored in the request history storing unit 123. As shown in the figure, this child terminal list 1600 includes, for each child terminal 108 connected to the parent terminal 107, a terminal ID 1601, a user name 1602, and a terminal name 1603. In the example of the figure, the child terminal list 1600 includes “Child A1” and “Child A2” as the user names 1602, and “Terminal 1” and “Terminal 2” as the terminal names 1603 for two child terminals 108 with terminal IDs 1601 “USO086” and “USO871”. respectively.

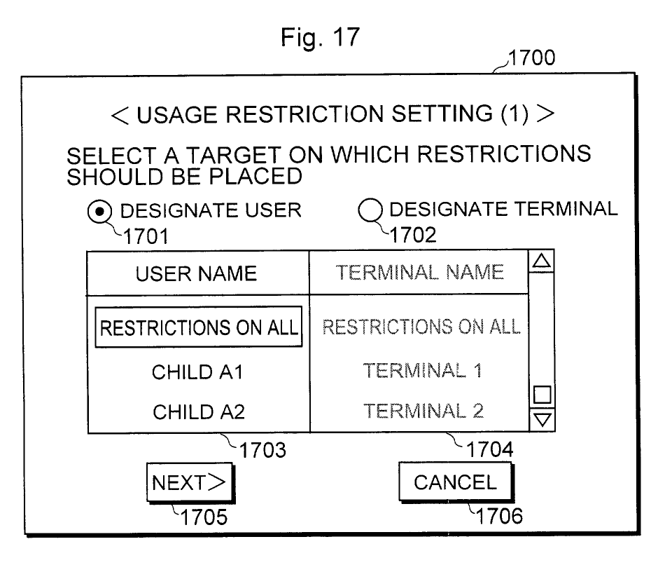

Having the parent terminal 107 store the above child terminal list 1600 enables the parental setting unit 120 to control parental restrictions in a greater variety of ways. FIG. 17 shows an example of a restriction setting screen 1700 presented by the parental setting unit 120 (shown in FIG. 8). As shown in the figure, the restriction setting screen 1700 includes, in its upper part, a user check box 1701 with a text “Designate User”, and a terminal check box 1702 with a text “Designate Terminal”. The user clicks one of the check boxes 1701 and 1702 to place restrictions on content use by either a designated user or a designated terminal. Displayed at the center of the screen 1700 are a user table 1703 and a terminal table 1704. The user table 1703 shows user names of child terminals 108 connected to the parent terminal 107, and the terminal table 1704 shows terminal names of these child terminals 108. These user names and terminal names are the same as those contained in the child terminal list 1600. The user names in the user table 1703 can be selected by the user only when the user check box 1701 is on. When the terminal check box 1702 is on, these user names are displayed using stippled letters, for instance, and cannot be selected by the user. The terminal table 1704 also functions similarly to the user table 1703.

The user table 1703 also contains an entry shown as “Restrictions on All”. When the user selects the user name “Child A1” and then presses a “Next” button 1705, restrictions set through the subsequent operations are placed only on the selected child user “Child A1”. On the other hand, when the user selects the item “Restrictions on All” and then presses the “Next” button 1705, the restrictions set through the subsequent operations are uniformly placed on all the child users displayed in the user table 1703. Similarly, the terminal table 1704 also contains an entry shown as “Restrictions on All”. When the user turns the terminal check box 1702 on, selects the item “Restrictions on All”, and then presses the “Next” button 1705, the restrictions set through the subsequent operations are uniformly placed on all child terminals 108 connected to the parent terminal 107. When the user presses a “Cancel” button 1706, all the data entered to this restriction setting screen 1700 is cleared, and the restriction setting operation is terminated.

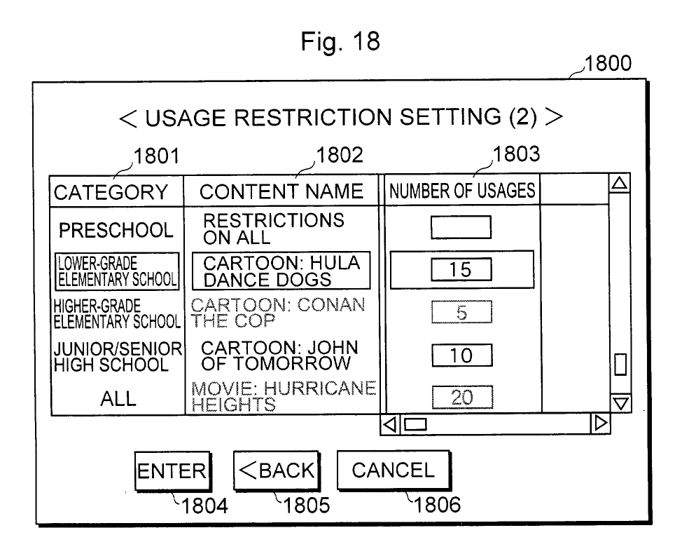

FIG. 18 shows an example of a second restriction setting screen 1800 invoked by the restriction setting screen 1700 shown in FIG. 17. The parent user enters, to this second restriction setting screen 1800, specific description of restrictions placed on the child user or the child terminal that the parent user has selected on the previous restriction setting screen 1700. As shown in the figure, the second restriction setting screen 1800 includes a category column 1801, a content name column 1802, and a number of usage column 1803. The category column 1801 includes a list of categories consisting of target age groups and content types, and the content name column 1802 includes an item shown as “Restrictions on All” and a list of names of usable contents for which the parent terminal 107 has license tickets. When the user selects the item shown as “Restrictions on All” in the content name column 1802, usage restrictions in the same row as the “Restrictions on All” item, such as a number of usages displayed in the column 1803, are placed uniformly on all the contents that fall under the selected category in the category column 1801. The number of usage column 1803 shows numbers of uses of the contents specified by the content names in the content name column 1802. The license tickets stored in the parent terminal 107 determine these numbers of uses in the column 1803. Note that when the item “Restrictions on All” in the content name column 1802 is selected, the number of usages displayed in the same row as this item in the number of usage column 1803 is applied as a maximum number of usages to all the contents that fall under the selected category in the column 1801.

The target age groups in the category column 1801 are age groups of target users, such as preschool children, elementary school children in the lower grades and higher grades, junior/senior high school students, and all age groups shown as “All”. The content types in the category column 1801 include movie, music, cartoon, game, news, sport, education, and hobby.

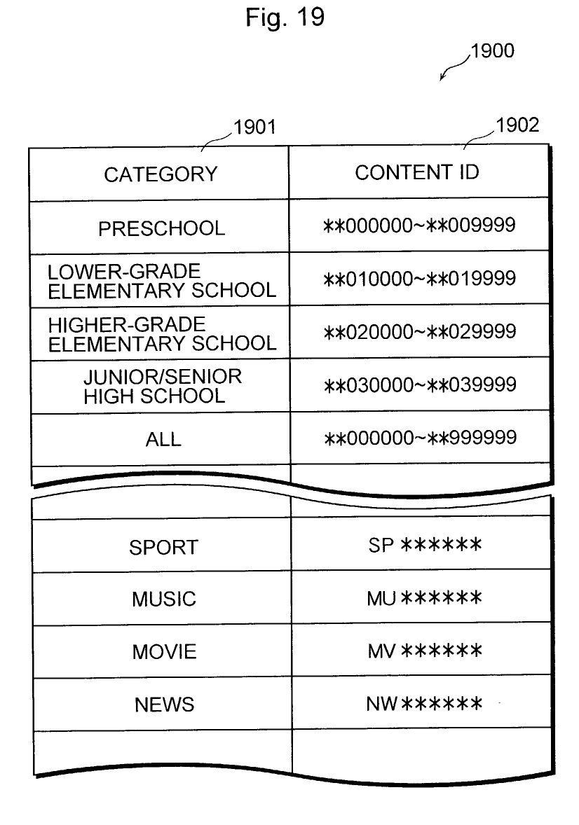

FIG. 19 shows an example of a content category table 1900 stored in the parental setting unit 120. This content category table 1900 includes lists of target age groups and content types such as the above in a category column 1901. The parental setting unit 120 that stores this content category table 1900 presents, within the category column 1801 of the second restriction setting screen 1800, items of the category column 1901 of the stored content category table 1900. The category table 1900 also contains, in a content ID column 1902, content IDs of contents categorized according to the categories in the category column 1901, and associates a group of content IDs with an appropriate category out of these categories. Each content ID shown in the figure consists of eight digits, of which lower six digits represent a target age group of the content and higher two digits represent a type of the content. For instance, with a content ID of a content targeting preschool children as its users, higher two digits of this content ID are wild cards shown as “**”, that is, any values, and lower six digits are shown as “000000”˜“009999”. With a content ID of a music content, higher two digits are shown as “MU”, and lower six digits are wild cards. With a music content targeting elementary school children in the lower grades, for instance, this content ID is shown as “MU010000˜MU019999”. With a content ID of a content in the age group category shown as “All”, higher two digits are wild cards, and lower six digits are shown as “000000˜999999”. That is to say, this category “All” includes all the contents. Although these target age group categories are represented by lower six digits of a content ID in this example, they may be represented otherwise. For instance, each target age group may be represented by two digits on the right of the highest two digits representing a content type.

The parental setting unit 120 refers to the content category table 1900 and a content ID 148 of each license ticket stored in the parent terminal 107, and judges whether the content ID 148 falls under a category in the category column 1801 currently selected by the parent user via the second restriction setting screen 1800. If so, the parental setting unit 120 presents, in the content name column 1802 of the second restriction setting screen 1800, a content name specified by the content ID 158 by using a normal typeface. If not, the parental setting unit 120 presents this content name by using stippled letters, thereby indicating that the content with this content name cannot be used. In the above judgment, the parental setting unit 120 judges the content ID 148 of a license ticket as not falling under the selected category if a target age group associated with the content ID 148 is an elder age group than an age group of the selected category. For instance, when the parent user selects the target age group “Lower-Grade Elementary School”, a content name of a cartoon “Hula Dance Dogs” whose ID is associated with a preschool children age group and a content name of a cartoon “John of Tomorrow” whose ID is associated with an age group for elementary school children in the lower grades are displayed within the content name column 1802 by using the normal typeface. A content name of the cartoon “Conan the Cop” whose ID is associated with the elementary school children in the higher grades, and a content name of a cartoon “Hurricane Heights” whose ID is associated with the adult age group, however, are displayed using stippled letters. On the right of the content names represented in the normal typeface in the content name column 1802, the numbers of uses permitted by license tickets for contents specified by these content names are displayed in the number of usage column 1803. The example of the figure shows that the cartoons “Hula Dance Dogs” and “John of Tomorrow” can be used up to “15” and “10” times, respectively.

When the user changes his selection in the category column 1801 from “Preschool” to “Lower-Grade Elementary School”, the content name of the cartoon “Conan the Cop” is displayed using the normal typeface. The number of usages “5” for this cartoon is also displayed using the normal typeface in the number of usage column 1803. When the user selects “All” in the category column 1801, content names of all the contents, whose license tickets are stored in the parent terminal 107, are displayed using the normal typeface.

The user can also select a content name represented by the normal typeface in the content name column 1802 so as to change its restriction written in the number use column 1803 on the right of the content name. For instance, after selecting the content name “Cartoon: Hula Dance Dogs” displayed using the normal typeface in the content name column 1802, the user can input “5” to overwrite “15” in the number of usage column 1803. Although not shown in the figure, columns such as for permitted continuous-usage hours, a valid period, and a valid time slot are also provided on the right of the number of usage column 1803. The user can scroll the screen to the right to overwrite each such item with a usage restriction so as to set a restriction more precisely in accordance with each selected content. If the user thinks such setting operation troublesome, he can simply select a category in the category column 1801 and press an “Enter” button 1804.

After completing input to the second restriction setting screen 1800, the user presses the “Enter” button 1804, so that the data entered to the restriction setting screen 1800 is placed as parental information 126 into the parental storing unit 121, and the display of the setting screen 1800 is terminated. This completes the restriction setting operation by the parental setting unit 120. When the user wishes, during input operation to the second restriction setting screen 1800, to change a child terminal 108 or a child user on which parental restrictions should be placed, the user presses a “Back” button 1805, so that data entered by the user to the second restriction setting screen 1800 so far is cleared, and the screen returns to the restriction setting screen 1700. A “Cancel” button 1806 functions in a similar way to the “Cancel” button 1706 on the restriction setting screen 1700.

In the second restriction setting screen 1800, target age groups and content types are written in the same category column 1801, and therefore the user can only restrict usable contents in accordance with either a target age group or a content type. When such target age groups and content types are displayed in separate columns to be selected by the user, the user can restrict usable contents in accordance with both an age group and a content type.

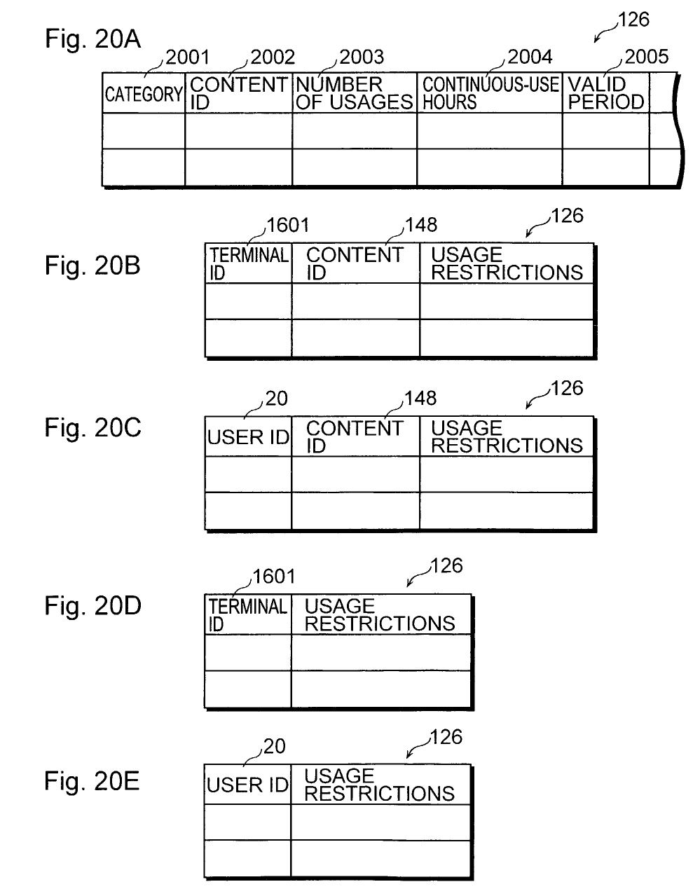

FIG. 20A shows the data structure of the parental information 126 generated from data inputted to the second restriction setting screen 1800 shown in FIG. 18. This parental information 126 includes such items as a category 2001, a content ID 2002, a number of usages 2003, continuous-usage durations 2004, and a valid period 2005. Each of these items has the same contents as data inputted to each column of the second restriction setting screen 1800. For instance, when the second restriction setting screen 1800 only receives a user input that selects a category in the category column 1801, this parental information 126 only contains information in the category item 2001, and other fields are blank. Once the user sets such parental information 126, the user does not have to set new usage restrictions after purchasing a new content and a usage right of the content, and contents usable by a child terminal 108 can be restricted to contents under the category item 2001.

When the user selects the item “Restrictions on All” in the content name column 1802 on the second usage restriction setting screen 1800, the parental information shown in FIG. 20A includes a wild card shown as “*”, for instance, as the content ID 2002. For instance, when the user selects the “Lower-Grade Elementary School” in the category column 1801, and the “Restrictions on All” item in the content name column 1802, the parental information 126 includes “Lower-Grade Elementary School” as the category 2001, and “*” as the content ID 2002. Then usage restrictions written in this parental information 126, such as the number of usages 2003, the continuous-usage hours 2004, and the valid period 2005, are placed uniformly on all the contents in the “Lower-Grade Elementary School” category. As the other example, when the user selects “All” in the category column 1801, and the “Restrictions on All” in the content name column 1802, the parental information 126 shown in FIG. 20A includes “All” as the category 2001, and “*” as the content ID 2002. Then usage restrictions written in this parental information 126 are placed uniformly on all the contents. When the user turns the user check box 1701 on and selects “Restrictions on All” on the restriction setting screen 1700, restrictions written in this parental information 126 are uniformly placed on all the child terminals 108 shown in the child terminal list 1600. For instance, when the category item 2001 is shown as “Lower-Grade Elementary School”, both the child terminal 108 with the terminal ID “USO086” of Child A1 and the child terminal 108 with the terminal ID “USO871” of Child A2 in the child terminal list 1600 can only use contents that fall under the category of “Lower-Grade Elementary School”. This restriction based on the category item 2001 is also placed on contents and license tickets purchased after this restriction has been set via the second restriction setting screen 1800. That is to say, when the newly purchased content falls under the category “Lower-Grade Elementary School”, both the child terminals 108 with the terminal IDs “USO086” and “USO871” can use this content. If this content falls under the category “Higher-Grade Elementary School” or a category of an elder age group, neither of these child terminals 108 can use this content.

FIGS. 20B˜20E show other examples of data structures of parental information 126 stored in the parental storing unit 121 shown in FIG. 8.

FIG. 20B shows parental information 126 in which usage restrictions are associated with a terminal ID 1601 and a content ID 148. With this data structure, valid usage restrictions are placed when a certain child terminal uses a certain content.

FIG. 20C shows parental information 126 in which usage restrictions are associated with a user ID 20 and a content ID 148. With this data structure, valid usage restrictions are placed when a certain user uses a certain content.

FIG. 20D shows parental information 126 in which usage restrictions are associated with a terminal ID 1601. With this data structure, the same usage restrictions are placed when a certain child terminal 108 uses any content.

FIG. 20E shows parental information 126 in which usage restrictions are associated with a user ID 20. With this data structure, the same usage restrictions are placed when a certain child user uses any content.

It is also possible for the parent user to set more precise restrictions on content use by a child user in accordance with the operation mode of each content, that is, how each content is used, although in the above examples the parent user simply places usage restrictions on each content.

With the above usage restriction setting and control, the adult user can precisely set usage restrictions on each child user. At the same time, the above restriction setting and control methods can save the adult user from having to perform troublesome input operations to set usage restrictions, and allow the user to set more rough usage restrictions.

With the above example modification, the parent terminal 107 registers all the child terminals 108, on which parental usage restrictions are to be placed, in the child terminal list 1600. Concerning child terminals 108 not registered in this child terminal list 1600, the parent terminal 107 may prohibit all content use by these child terminals 108.

As has been described, the present invention can be embodied as a license management server and terminal devices that make up a usage restriction control (license management) system. The present invention can be also embodied as a usage restriction control method, particularly a parental control method, used for the license management server and the terminal devices, and as programs to have a computer perform characteristic steps of these methods. These programs may be stored on recording media such as CD-ROMs (read-only memory) to be distributed via a communication network and the like.

### INDUSTRIAL APPLICABILITY

The terminal device of the present invention is useful as a server used in a home, particularly for a child user in the home to receive a digital content via the Internet and the like from a content distribution system. The license management server of the present invention is useful as a server that is included in the content distribution system distributing digital contents to each home and that collectively manages usage license of these contents.

1. A license management server that manages usage rules in accordance with which terminal devices use contents, wherein the terminal devices include a first terminal device used by a first user and a second terminal device used by a second user, comprising:
an information storing unit operable to store license information that associates a usage rule with either (a) each of the first terminal device and the second terminal device or (b) each of the first user and the second user;
a restriction managing unit operable to obtain restriction information from either the first terminal device or the first user and to store the restriction information, which shows a restriction on content use by either the second terminal device or the second user; and
a ticket issuing unit operable to (1) obtain a usage request from either the first terminal device or the first user, the obtained usage request requesting content use by either the second terminal device or the second user, (2) add, in response to the obtained usage request, the restriction shown in the restriction information in the restriction managing unit to a usage rule associated by the license information with one of the first terminal device, the first user, the second terminal device, and the second user to produce a new usage rule, (3) produce a first license ticket that permits content use under the new usage rule, and (4) send the first license ticket to either the first terminal device or the first user.

2. The license management server of claim 1, further comprising:
a rejection obtaining unit operable to obtain an instruction from either the first terminal device or the first user, the instruction instructing to reject a usage request directly sent from either the second terminal device or the second user; and
a rejecting unit operable to reject the usage request that is directly sent from either the second terminal device or the second user indicated by the obtained instruction.

3. The license management server of claim 1,
wherein the ticket issuing unit also obtains a usage request requesting a content use by either the first terminal device or the first user, and produces a second license ticket that permits the content use under a usage rule associated by the license information with either the first terminal device or the first user,
wherein when obtaining two usage requests requesting use of the same content by (a) either the first terminal device or the first user and (b) either the second terminal device or the second user, the ticket issuing unit produces first and second license tickets responding to the two usage requests, and places the first license ticket in the second license ticket.

4. A terminal device that makes a request for content use to a license management server that manages usage rules for contents, comprising:
a restriction storing unit operable to obtain and store restriction information showing a restriction to be placed on content use by either a certain terminal device or a certain user of the certain terminal device;
a ticket requesting unit operable to make a ticket request to the license management server in response to a request from either the certain terminal device or the certain user, the ticket request requesting a license ticket that permits content use under a certain usage rule;
a ticket obtaining unit operable to obtain the requested license ticket from the license management server; and
a ticket issuing unit operable to (1) add the restriction shown in the restriction information in the restriction storing unit to the certain usage rule shown in the obtained license ticket to produce a new usage rule, (2) produce a restricted license ticket that permits the content use under the new usage rule, and (3) send the restricted license ticket to either the certain terminal device or the certain user.

5. The terminal device of claim 4,
wherein the ticket issuing unit revises the certain usage rule to the new usage rule to produce the restricted license ticket.

6. The terminal device of claim 4,
wherein the ticket issuing unit produces the restricted license ticket that shows the new usage rule in such a way as to indicate correspondence between the certain usage rule and the restriction.

7. The terminal device of claim 4,
wherein the ticket issuing unit also produces a secondary license ticket that only shows the new usage rule, attaches the secondary license ticket to the obtained license ticket, and handles the obtained license ticket to which the secondary license ticket is attached as the restricted license ticket.

8. The terminal device of claim 4, further comprising
a stopping unit operable to receive, from a user of the terminal device, an instruction to stop content use by either the certain terminal device or the certain user, and to send a stop signal to the certain terminal device in response to the instruction.

9. The terminal device of claim 4,
wherein the ticket requesting unit makes a ticket request for a plurality of license tickets that each permit content use under a different usage rule,
the ticket obtaining unit also obtains the plurality of license tickets, and
the ticket issuing unit also selects a license ticket out of the plurality of license tickets obtained by the ticket obtaining unit, the selected license ticket permitting content use under a usage rule closest to the new usage rule, and handles the selected license ticket as the restricted license ticket.

10. The terminal device of claim 4, further comprising
a residual ticket producing unit operable to produce a residual license ticket that permits content use by either the certain terminal device or the certain user under a usage rule based on a differential between a range of the certain usage rule shown in the obtained license ticket and a range of the new usage rule shown in the restricted license ticket,
wherein the ticket issuing unit generates the restricted license ticket when a range of the new usage rule shown in the restricted license ticket is estimated to be within a range of the usage rule shown in the residual license ticket.

11. The terminal device of claim 4, further comprising:
an easing information storing unit operable to store restriction easing information showing that the restriction shown in the restriction information can be eased to a certain degree in accordance with a condition predetermined by a user of the terminal device;
a judging unit operable to judge whether the ticket request satisfies the predetermined condition shown in the restriction easing information; and
an easing unit operable to (1) request, when the judging unit judges that the ticket request satisfies the predetermined condition, the management server to issue an easing license ticket that permits the content use under a usage rule, to which the restriction that has been eased to the certain degree is added, (2) obtain the easing license ticket from the management server, and (3) send the easing license ticket to either the certain terminal device or the certain user.

12. The terminal device of claim 4,
wherein the restriction storing unit obtains and stores the restriction information showing the restriction to be placed on use of any content by the certain terminal device, and
the ticket issuing unit sends, in response to the request for use of any content from the certain terminal device, the restricted license ticket to the certain terminal device.

13. The terminal device of claim 4,
wherein the restriction storing unit obtains and stores the restriction information showing the restriction to be placed on use of any content by the certain user, and
the ticket issuing unit sends, in response to the request for use of any content from the certain user, the restricted license ticket to the certain user.

14. The terminal device of claim 4,
wherein the restriction storing unit obtains and stores the restriction information showing the restriction to be placed on content use by the certain terminal device, the restriction being placed in accordance with a content to be used, and
the ticket issuing unit sends, in response to the request from the certain terminal device, the restricted license ticket to the certain terminal device.

15. The terminal device of claim 4,
wherein the restriction storing unit obtains and stores the restriction information showing the restriction to be placed on content use by the certain user, the restriction being placed in accordance with a content to be used, and
the ticket issuing unit sends, in response to the request from the certain user, the restricted license ticket to the certain user.

16. A license management system that comprises a license management server and a plurality of terminal devices, the license management server managing usage rules in accordance with which the terminal devices use contents, the terminal devices including a first terminal device used by a first user and a second terminal device used by a second user, each terminal device making a request for content use to the license management server,
wherein the license management server includes:
an information storing unit operable to store license information that associates a usage rule with either (a) each of the first terminal device and the second terminal device or (b) each of the first user and the second user;
a restriction managing unit operable to obtain restriction information from either the first terminal device or the first user and to store the restriction information, which shows a restriction on content use by either the second terminal device or the second user;
a ticket issuing unit operable to (1) obtain a usage request from either the first terminal device or the first user, the obtained usage request requesting content use by either the second terminal device or the second user, (2) add, in response to the obtained usage request, the restriction shown in the restriction information in the restriction managing unit to a usage rule associated by the license information with one of the first terminal device, the first user, the second terminal device, and the second user to produce a new usage rule, (3) produce a first license ticket that permits content use under the new usage rule, and (4) send the first license ticket to either the first terminal device or the first user,
the first terminal device includes:
a restriction sending unit operable to send the restriction information to the license management server;
a first usage requesting unit operable to make the usage request requesting issuance of the first license ticket to the license management server in response to a request from either the second terminal device or the second user;
a first ticket obtaining unit operable to obtain the requested first license ticket from the license management server and send the obtained first license ticket to either the second terminal device of the second user; and
the second terminal device includes:
a second usage requesting unit operable to make the request for content use to either the first terminal device or the first user;
a second ticket obtaining unit operable to obtain the first license ticket from either the first terminal device or the first user; and
a using unit operable to use the content in accordance with the obtained first license ticket.

17. The license management system of claim 16, wherein the license management server also includes:
a rejection obtaining unit operable to obtain an instruction from either the first terminal device or the first user, the instruction instructing to reject a usage request directly sent from either the second terminal device or the second user; and
a rejecting unit operable to reject the usage request that is directly sent from either the second terminal device or the second user indicated by the obtained instruction.

18. The license management system of claim 16,
wherein the ticket issuing unit also obtains a usage request requesting a content use by either the first terminal device or the first user, and produces a second license ticket that permits the content use under a usage rule associated by the license information with either the first terminal device or the first user,
wherein when obtaining two usage requests requesting use of the same content by (a) either the first terminal device or the first user and by (b) either the second terminal device or the second user, the ticket issuing unit produces first and second license tickets responding to the two usage requests, and places the first license ticket in the second license ticket, and
the first ticket obtaining unit receives the second license ticket in which the first license ticket is placed, extracts the first license ticket from the second license ticket, and sends the extracted first license ticket to either the second terminal device or the second user.

19. The license management system of claim 16,
wherein the first terminal device also includes a stopping unit operable to receive, from the first user, an instruction to stop content use by either the second terminal device or the second user, and to send a stop signal to the second terminal device in response to the instruction, and
the second terminal device also includes a usage stopping unit operable to receive the stop signal and stop the use by the using unit.

20. A license management system that comprises a license management server and a plurality of terminal devices, the license management server managing usage rules in accordance with which the terminal devices use contents, the terminal devices including a first terminal device used by a first user and a second terminal device used by a second user, each terminal device making a request for content use to the license management server,
wherein the license management server includes:
an information storing unit operable to store license information that associates a usage rule with either (a) each of the first terminal device and the second terminal device or (b) each of the first user and the second user; and
a ticket issuing unit operable to obtain a usage request from either the first terminal device or the first user, the obtained usage request requesting content use by either the second terminal device or the second user, (2) produce a license ticket that permits content use under a usage rule associated by the license information with one of the first user, the first terminal, the second user, and the second terminal, and (3) send the produced license ticket to either the first terminal device or the first user,
the first terminal device includes:
a restriction storing unit operable to obtain and store restriction information showing a restriction to be placed on content use by either the second terminal device or the second user;
a first usage requesting unit operable to make the usage request requesting issuance of the license ticket to the license management server in response to a request from either the second terminal device or the second user;
a first ticket obtaining unit operable to obtain the license ticket from the license management server; and
a restricted ticket issuing unit operable to (1) add the restriction shown in the restriction information in the restriction storing unit to the usage rule shown in the obtained license ticket to produce a new usage rule, (2) produce a restricted license ticket that permits the content use under the new usage rule, and (3) send the restricted license ticket to either the second terminal device or the second user, and
the second terminal device includes:
a second usage requesting unit operable to make the request for content use to either the first terminal device or the first user;
a second ticket obtaining unit operable to obtain the restricted license ticket from either the first terminal device or the first user; and
a using unit operable to use the content in accordance with the obtained restricted license ticket.

21. The license management system of claim 20,
wherein the restricted ticket issuing unit revises the usage rule shown in the obtained license ticket to the new usage rule to produce the restricted license ticket.

22. The license management system of claim 20,
wherein the restricted ticket issuing unit produces the restricted license ticket that shows a plurality of usage rules including the new usage rule that is shown in a predetermined part of the restricted license ticket, and
the using unit uses the content under the new usage rule out of the plurality of usage rules.

23. The license management system of claim 20,
wherein the restricted license ticket issuing unit also produces a secondary license ticket that only shows the new usage rule, attaches the secondary license ticket to the license ticket obtained by the first ticket obtaining unit, and handles the obtained license ticket to which the secondary license ticket is attached as the restricted license ticket, and
the using unit specifies a logical product of the new usage rule and the usage rule that are shown in the obtained restricted license ticket, and uses the content under a usage rule corresponding to the specified logical product.

24. The license management system of claim 20, wherein
the first usage requesting unit makes a usage request for a plurality of license tickets that each permit content use under a different usage rule,
the first ticket obtaining unit also obtains the plurality of license tickets, and
the restricted ticket issuing unit also selects a license ticket out of the plurality of license tickets obtained by the first ticket obtaining unit, the selected license ticket permitting content use under a usage rule closest to the new usage rule, and handles the selected license ticket as the restricted license ticket.

25. The license management system of claim 20, wherein
the first terminal device also includes:
a residual ticket producing unit operable to produce a residual license ticket that permits content use by either the second terminal device or the second user under a usage rule based on a differential between (a) a range of the usage rule shown in the license ticket obtained by the first ticket obtaining unit and (b) a range of the new usage rule shown in the restricted license ticket,
wherein the restricted ticket issuing unit produces the restricted license ticket when a range of the new usage rule shown in the restricted license ticket is estimated to be within a range of the usage rule shown in the residual license ticket.

26. The license management system of claim 20,
wherein the first terminal device also includes:
an easing information storing unit operable to store restriction easing information showing that the restriction shown in the restriction information can be eased to a certain degree in accordance with a condition predetermined by the first user;
a judging unit operable to judge whether the request form the second terminal device satisfies the predetermined condition shown in the restriction easing information; and
an easing unit operable to (1) request, when the judging unit judges that the request satisfies the predetermined condition, the license management server to issue an easing license ticket that permits the content use under a usage rule, to which the restriction that has been eased to the certain degree is added, (2) obtain the easing license ticket from the license management server, and (3) send the easing license ticket to either the second terminal device or the second user, and
the second terminal device also includes:
an additional using unit operable to obtain the easing license ticket from the easing unit and use the content in accordance with the easing license ticket.

27. The license management system of claim 20,
wherein the first terminal device also includes a stopping unit operable to receive, from the first user, an instruction to stop content use by either the second terminal device or the second user, and to send a stop signal to the second terminal device in response to the instruction, and
the second terminal device also includes a usage stopping unit operable to receive the stop signal and stop the use by the using unit.

28. The license management system of claim 20,
wherein the license management server also includes:
a rejection obtaining unit operable to obtain an instruction from either the first terminal device or the first user, the instruction instructing to reject a usage request directly sent from either the second terminal device or the second user; and
a rejecting unit operable to reject the usage request that is directly sent from either the second terminal device or the second user indicated by the obtained instruction.

29. A usage restriction control method for a license management server that manages usage rules in accordance with which terminal devices use contents,
wherein the terminal devices include a first terminal device used by a first user and a second terminal device used by a second user, the license management server includes (a) a license information storing unit operable to store license information that associates a usage rule with either each of the first terminal device and the second terminal device or each of the first user and the second user, and (b) a restriction information storing unit operable to store restriction information which shows a restriction on content use by either the second terminal device or the second user, and
the usage restriction control method includes:
a step for obtaining the restriction information from either the first terminal device or the first user and placing the restriction information into the restriction information storing unit;
a step for (1) obtaining a usage request from either the first terminal device or the first user, the obtained usage request requesting content use by either the second terminal device or the second user, (2) adding, in response to the obtained usage request, the restriction shown in the restriction information in the restriction storing unit to a usage rule associated by the license information with one of the first terminal device, the first user, the second terminal device, and the second user to produce a new usage rule, (3) producing a license ticket that permits content use under the new usage rule, and (4) sending the license ticket to either the first terminal device or the first user.

30. A program to have a computer function as a license management server that manages usage rules in accordance with which terminal devices use contents,
wherein the terminal devices include a first terminal device used by a first user and a second terminal device used by a second user, the license management server includes (a) a license information storing unit operable to store license information that associates a usage rule with either each of the first terminal device and the second terminal device or each of the first user and the second user, and (b) a restriction information storing unit operable to store restriction information which shows a restriction on content use by either the second terminal device or the second user, and
the program includes:
a step for obtaining the restriction information from either the first terminal device or the first user and placing the restriction information into the restriction information storing unit;
a step for (1) obtaining a usage request from either the first terminal device or the first user, the obtained usage request requesting content use by either the second terminal device or the second user, (2) adding, in response to the obtained usage request, the restriction shown in the restriction information in the restriction storing unit to a usage rule associated by the license information with one of the first terminal device, the first user, the second terminal device, and the second user to produce a new usage rule, (3) producing a license ticket that permits content use under the new usage rule, and (4) sending the license ticket to either the first terminal device or the first user.

31. A usage restriction control method for a terminal device that makes a request for content use to a license management server that manages usage rules of contents,
wherein the terminal device includes a restriction storing unit operable to store restriction information showing a restriction to be placed on content use by either a certain terminal device or a certain user of the certain terminal device, and
the usage restriction control method includes:
a step for obtaining the restriction information and placing the obtained restriction information into the restriction storing unit;
a step for making a ticket request to the license management server in response to a request from either the certain terminal device or the certain user, the ticket request requesting a license ticket that permits content use under a certain usage rule;
a step for obtaining the requested license ticket from the license management server; and
a step for (1) adding the restriction shown in the restriction information in the restriction storing unit to the certain usage rule shown in the obtained license ticket to produce a new usage rule, (2) producing a restricted license ticket that permits the content use under the new usage rule, and (3) sending the restricted license ticket to either the certain terminal device or the certain user.

32. A program to have a computer function as a terminal device that makes a request for content use to a license management server that manages usage rules of contents,
wherein the terminal device includes a restriction storing unit operable to store restriction information showing a restriction to be placed on content use by either a certain terminal device or a certain user of the certain terminal device, and
the program includes:
a step for obtaining the restriction information and placing the obtained restriction information into the restriction storing unit;
a step for making a ticket request to the license management server in response to a request from either the certain terminal device or the certain user, the ticket request requesting a license ticket that permits content use under a certain usage rule;
a step for obtaining the requested license ticket from the license management server; and
a step for (1) adding the restriction shown in the restriction information in the restriction storing unit to the certain usage rule shown in the obtained license ticket to produce a new usage rule, (2) producing a restricted license ticket that permits the content use under the new usage rule, and (3) sending the restricted license ticket to either the certain terminal device or the certain user.
